(19) United States
(12) Patent Application Publication
(10) Pub. No.: US 2026/0365679 A1
(43) Pub. Date: Nov. 19, 2026

(54) METHODS OF MAKING STANNIC ALKOXIDES AND STANNIC AMIDES

(71) Applicant: ENTEGRIS, INC., Billerica, MA (US)

(72) Inventors: David M. Ermert, Danbury, CT (US); Scott A. Laneman, Vernon Hills, IL (US)

(21) Appl. No.: 19/644,972

(22) Filed: Apr. 10, 2026

Related U.S. Application Data
(60) Provisional application No. 63/792,296, filed on Apr. 21, 2025.

(51) Int. Cl. C07F 7/22

(52) U.S. Cl. CPC C07F 7/2224

(57) ABSTRACT

Methods for the synthesis of stannic alkoxides, stannic amides, and related compositions are provided. Some embodiments of the method include contacting an elemental tin component, a peroxide, and a solvent to form a tin (IV) alkoxide. Some embodiments of the method include contacting a tin (II) alkoxide, a peroxide, and a solvent to form a tin (IV) alkoxide. Some embodiments of the method include contacting an elemental tin component, an elemental copper component, a peroxide, and a solvent to form a tin (IV) alkoxide. Some embodiments of the method include contacting a tin (II) alkoxide, a copper (II) alkoxide, and a solvent to form a tin (IV) alkoxide.

### CROSS-REFERENCE TO RELATED APPLICATIONS

This application claims the benefit under 35 USC 119 of U.S. Provisional Patent Application No. 63/792,296, filed Apr. 21, 2025, the disclosure of which is hereby incorporated herein by reference in its entirety.

### FIELD

The present disclosure relates to methods of making stannic alkoxides and stannic amides.

### BACKGROUND

Some precursors are useful in the manufacture of microelectronic devices. The manufacture of such devices can involve the use of deposition processes to form thin films, as well as extreme ultraviolet (EUV) lithography to pattern features on thin films. There has been recent interest in the use of tin compounds in this application. Preparing useful tin compounds economically and of sufficient purity remains an ongoing challenge.

### SUMMARY

Some embodiments relate to a method. In some embodiments, the method comprises contacting at least a tin (II) alkoxide compound, a peroxide compound, and a solvent to form a tin (IV) alkoxide compound. In some embodiments, the tin (II) alkoxide compound comprises a compound of the formula:

Sn(OR¹)₂,
where R¹ independently comprises a hydrocarbyl group. In some embodiments, the peroxide compound comprises a compound of the formula:

R²O—OR²,
where R² independently comprises a hydrocarbyl group. In some embodiments, the tin (IV) alkoxide compound comprises a compound of the formula:

Sn(OR¹)₂(OR²)₂,
where R¹ and R² independently comprise a hydrocarbyl group.

Some embodiments relate to a method. In some embodiments, the method comprises contacting at least an elemental tin component, a peroxide compound, and a solvent to form a tin (IV) alkoxide compound. In some embodiments, the peroxide compound comprises a compound of the formula:

R¹O—OR¹,
where R¹ independently comprises a hydrocarbyl group. In some embodiments, the tin (IV) alkoxide compound comprises a compound of the formula:

Sn(OR¹)₄,
where R¹ independently comprises a hydrocarbyl group.

Some embodiments relate to a method. In some embodiments, the method comprises contacting at least a tin (II) alkoxide compound, a copper (II) alkoxide compound, and a solvent to form a tin (IV) alkoxide compound. In some embodiments, the tin (II) alkoxide compound comprises a compound of the formula:

Sn(OR¹)₂,
where R¹ independently comprises a hydrocarbyl group. In some embodiments, the tin (IV) alkoxide compound comprises a compound of the formula:

Sn(OR¹)₂(OR²)₂,
where R¹ and R² independently comprise a hydrocarbyl group.

Some embodiments relate to a method. In some embodiments, the method comprises contacting at least an elemental tin component, an elemental copper component, a peroxide component, and a solvent to form a tin (IV) alkoxide compound. In some embodiments, the peroxide compound comprises a compound of the formula:

R¹O—OR¹,
where R¹ independently comprises a hydrocarbyl group. In some embodiments, the tin (IV) alkoxide compound comprises a compound of the formula:

Sn(OR¹)₄,
where R¹ independently comprises a hydrocarbyl group.

Some embodiments relate to a composition. In some embodiments, the composition comprises a tin (IV) alkoxide compound. In some embodiments, the tin (IV) alkoxide compound comprises a compound of the formula:

Sn(OR)₄,
where R independently comprises a hydrocarbyl group. In some embodiments, the composition comprises less than 1% by weight of a halide based on a total weight of the composition.

Some embodiments relate to a method. In some embodiments, the method comprises contacting at least a tin (II) amide compound, a copper (II) amide compound, and a solvent to form a tin (IV) amide compound. In some embodiments, the tin (II) amide compound comprises a compound of the formula:

Sn(NR¹₂)₂,
where R¹ independently comprises a hydrocarbyl group. In some embodiments, the tin (IV) amide compound comprises a compound of the formula:

Sn(NR¹₂)₂(NR²₂)₂,
where R¹ and R² independently comprises a hydrocarbyl group.

Some embodiments relate to a method. In some embodiments, the method comprises contacting at least a copper (II) compound, a metal amide compound, and a solvent to form a copper (II) amide compound. In some embodiments, the copper (II) compound comprises a compound of the formula:

CuY₂,
where Y independently comprises at least one of a halide, a sulfate, an acetate, an oxalate, an acetylacetonate, a nitrate, or any combination thereof. In some embodiments, the metal amide compound comprises a compound of the formula:

M(NR¹₂)ₙ,
where M comprises at least one of an alkali metal, an alkaline earth metal, or any combination thereof. In some embodiments, R¹ independently comprises a hydrocarbyl group. In some embodiments, n is 1 or 2. In some embodiments, the copper (II) amide compound comprises a compound of the formula:

Cu(NR¹₂)₂,
where R¹ independently comprises a hydrocarbyl group.

Some embodiments relate to a composition. In some embodiments, the composition comprises a tin (IV) amide compound. In some embodiments, the tin (IV) amide compound comprises a compound of the formula:

Sn(NR₂)₄,
where R independently comprises a hydrocarbyl group. In some embodiments, the composition comprises less than 1% by weight of a halide based on a total weight of the composition.

### BRIEF DESCRIPTION OF THE DRAWINGS

FIG. 1 is a flowchart of a method for making tin (IV) alkoxide, according to some embodiments.

FIG. 2 is a flowchart of a method for making tin (IV) alkoxide, according to some embodiments.

FIG. 3 is a flowchart of a method for making tin (IV) alkoxide, according to some embodiments.

FIG. 4 is a 3-dimensional molecular structure of a copper (II) chloride/alkoxide/lithium complex, according to some embodiments.

FIG. 5 is a schematic diagram of a method for making tin (IV) alkoxide, according to some embodiments.

FIG. 6 is a schematic diagram of a method for making tin (IV) alkoxide, according to some embodiments.

FIG. 7 is a schematic diagram of a method for making tin (IV) alkoxide, according to some embodiments.

### DETAILED DESCRIPTION

As used herein, the term “hydrocarbyl” refers to a functional group derived from a hydrocarbon by removing at least one hydrogen atom. The term includes, for example and without limitation, at least one of an alkyl, an alkenyl, an alkynyl, an aryl, a cycloalkyl, or any combination thereof.

As used herein, the term “contacting” refers to bringing two or more components into immediate or close proximity, or into direct contact.

As used herein, the term “alkyl” refers to a hydrocarbyl having from 1 to 30 carbon atoms. The alkyl may be attached via a single bond. An alkyl having n carbon atoms may be designated as a “Cₙ alkyl.” For example, a “C₃ alkyl” may include n-propyl and isopropyl. An alkyl having a range of carbon atoms, such as 1 to 30 carbon atoms, may be designated as a C₁-C₃₀ alkyl. In some embodiments, the alkyl is linear. In some embodiments, the alkyl is branched. In some embodiments, the alkyl is substituted. In some embodiments, the alkyl is unsubstituted. In some embodiments, the alkyl comprises or is selected from the group consisting of at least one of a C₁-C₃₀ alkyl, C₁-C₂₉ alkyl, C₁-C₂₈ alkyl, C₁-C₂₇ alkyl, C₁-C₂₆ alkyl, C₁-C₂₅ alkyl, C₁-C₂₄ alkyl, C₁-C₂₃ alkyl, C₁-C₂₂ alkyl, C₁-C₂₁ alkyl, C₁-C₂₀ alkyl, C₁-C₁₉ alkyl, C₁-C₁₈ alkyl, C₁-C₁₇ alkyl, C₁-C₁₆ alkyl, C₁-C₁₅ alkyl, C₁-C₁₄ alkyl, C₁-C₁₃ alkyl, C₁-C₁₂ alkyl, C₁-C₁₁ alkyl, C₁-C₁₀ alkyl, a C₁-C₉ alkyl, a C₁-C₈ alkyl, a C₁-C₇ alkyl, a C₁-C₆ alkyl, a C₁-C₅ alkyl, a C₁-C₄ alkyl, a C₁-C₃ alkyl, a C₁-C₂ alkyl, a C₂-C₃₀ alkyl, a C₃-C₃₀ alkyl, a C₄-C₃₀ alkyl, a C₅-C₃₀ alkyl, a C₆-C₃₀ alkyl, a C₇-C₃₀ alkyl, a C₈-C₃₀ alkyl, a C₉-C₃₀ alkyl, a C₁₀-C₃₀ alkyl, a C₁₁-C₃₀ alkyl, a C₁₂-C₃₀ alkyl, a C₁₃-C₃₀ alkyl, a C₁₄-C₃₀ alkyl, a C₁₅-C₃₀ alkyl, a C₁₆-C₃₀ alkyl, a C₁₇-C₃₀ alkyl, a C₁₈-C₃₀ alkyl, a C₁₉-C₃₀ alkyl, a C₂₀-C₃₀ alkyl, a C₂₁-C₃₀ alkyl, a C₂₂-C₃₀ alkyl, a C₂₃-C₃₀ alkyl, a C₂₄-C₃₀ alkyl, a C₂₅-C₃₀ alkyl, a C₂₆-C₃₀ alkyl, a C₂₇-C₃₀ alkyl, a C₂₈-C₃₀ alkyl, a C₂₉-C₃₀ alkyl, a C₂-C₁₀ alkyl, a C₃-C₁₀ alkyl, a C₄-C₁₀ alkyl, a C₅-C₁₀ alkyl, a C₆-C₁₀ alkyl, a C₇-C₁₀ alkyl, a C₈-C₁₀ alkyl, a C₂-C₉ alkyl, a C₂-C₈ alkyl, a C₂-C₇ alkyl, a C₂-C₆ alkyl, a C₂-C₅ alkyl, a C₃-C₅ alkyl, or any combination thereof. In some embodiments, the alkyl comprises or is selected from the group consisting of at least one of methyl, ethyl, n-propyl, 1-methylethyl (iso-propyl), n-butyl, iso-butyl, sec-butyl, n-pentyl, 1,1-dimethylethyl (t-butyl), n-pentyl, iso-pentyl, n-hexyl, isohexyl, 3-methylhexyl, 2-methylhexyl, heptyl, octyl, nonyl, decyl, dodecyl, octadecyl, or any combination thereof. In some embodiments, the term “alkyl” refers generally to alkyls, alkenyls, alkynyls, and/or cycloalkyls.

As used herein, the term “alkenyl” refers to a hydrocarbyl having from 2 to 30 carbon atoms and at least one carbon-carbon double bond. In some embodiments, the alkenyl comprises or is selected from the group consisting of at least one of a C₂-C₃₀ alkenyl, C₂-C₂₉ alkenyl, C₂-C₂₈ alkenyl, C₂-C₂₇ alkenyl, C₂-C₂₆ alkenyl, C₂-C₂₅ alkenyl, C₂-C₂₄ alkenyl, C₂-C₂₃ alkenyl, C₂-C₂₂ alkenyl, C₂-C₂₁ alkenyl, C₂-C₂₀ alkenyl, C₂-C₁₉ alkenyl, C₂-C₁₈ alkenyl, C₂-C₁₇ alkenyl, C₂-C₁₆ alkenyl, C₂-C₁₅ alkenyl, C₂-C₁₄ alkenyl, C₂-C₁₃ alkenyl, C₂-C₁₂ alkenyl, C₂-C₁₁ alkenyl, C₂-C₁₀ alkenyl, a C₂-C₉ alkenyl, a C₂-C₈ alkenyl, a C₂-C₇ alkenyl, a C₂-C₆ alkenyl, a C₂-C₅ alkenyl, a C₂-C₄ alkenyl, a C₂-C₃ alkenyl, a C₂ alkenyl, a C₂-C₃₀ alkenyl, a C₃-C₃₀ alkenyl, a C₄-C₃₀ alkenyl, a C₅-C₃₀ alkenyl, a C₆-C₃₀ alkenyl, a C₇-C₃₀ alkenyl, a C₈-C₃₀ alkenyl, a C₉-C₃₀ alkenyl, a C₁₀-C₃₀ alkenyl, a C₁₁-C₃₀ alkenyl, a C₁₂-C₃₀ alkenyl, a C₁₃-C₃₀ alkenyl, a C₁₄-C₃₀ alkenyl, a C₁₅-C₃₀ alkenyl, a C₁₆-C₃₀ alkenyl, a C₁₇-C₃₀ alkenyl, a C₁₈-C₃₀ alkenyl, a C₁₉-C₃₀ alkenyl, a C₂₀-C₃₀ alkenyl, a C₂₁-C₃₀ alkenyl, a C₂₂-C₃₀ alkenyl, a C₂₃-C₃₀ alkenyl, a C₂₄-C₃₀ alkenyl, a C₂₅-C₃₀ alkenyl, a C₂₆-C₃₀ alkenyl, a C₂₇-C₃₀ alkenyl, a C₂₈-C₃₀ alkenyl, a C₂₉-C₃₀ alkenyl, a C₂-C₁₀ alkenyl, a C₃-C₁₀ alkenyl, a C₄-C₁₀ alkenyl, a C₅-C₁₀ alkenyl, a C₆-C₁₀ alkenyl, a C₇-C₁₀ alkenyl, a C₈-C₁₀ alkenyl, a C₂-C₉ alkenyl, a C₂-C₈ alkenyl, a C₂-C₇ alkenyl, a C₂-C₆ alkenyl, a C₂-C₅ alkenyl, a C₃-C₅ alkenyl, or any combination thereof. Examples of alkenyl groups include, without limitation, at least one of vinyl, allyl, 1-methylvinyl, 1-propenyl, 1-butenyl, 2-butenyl, 3-butenyl, 1,3-butadienyl, 2-methyl-1-propenyl, 2-methyl-2-propenyl, 1-pentenyl, 2-pentenyl, 3-pentenyl, 4-pentenyl, 1,3-pentadienyl, 2,4-pentadienyl, 1,4-pentadienyl, 3-methyl-2-butenyl, 1-hexenyl, 2-hexenyl, 3-hexenyl, 1,3-hexadienyl, 1,4-hexadienyl, 2-methylpentenyl, 1-heptenyl, 3-heptenyl, 1-octenyl, 1,3-octadienyl, 1-nonenyl, 2-nonenyl, 3-nonenyl, 1-decenyl, 3-decenyl, 1-undecenyl, oleyl, linoleyl, linolenyl, or any combination thereof.

As used herein, the term “alkynyl” refers to a hydrocarbyl having from 2 to 30 carbon atoms and at least one carbon-carbon triple bond. In some embodiments, the alkynyl comprises or is selected from the group consisting of at least one of a C₂-C₃₀ alkynyl, C₂-C₂₉ alkynyl, C₂-C₂₈ alkynyl, C₂-C₂₇ alkynyl, C₂-C₂₆ alkynyl, C₂-C₂₅ alkynyl, C₂-C₂₄ alkynyl, C₂-C₂₃ alkynyl, C₂-C₂₂ alkynyl, C₂-C₂₁ alkynyl, C₂-C₂₀ alkynyl, C₂-C₁₉ alkynyl, C₂-C₁₈ alkynyl, C₂-C₁₇ alkynyl, C₂-C₁₆ alkynyl, C₂-C₁₅ alkynyl, C₂-C₁₄ alkynyl, C₂-C₁₃ alkynyl, C₂-C₁₂ alkynyl, C₂-C₁₁ alkynyl, C₂-C₁₀ alkynyl, a C₂-C₉ alkynyl, a C₂-C₈ alkynyl, a C₂-C₇ alkynyl, a C₂-C₆ alkynyl, a C₂-C₅ alkynyl, a C₂-C₄ alkynyl, a C₂-C₃ alkynyl, a C₂ alkynyl, a C₂-C₃₀ alkynyl, a C₃-C₃₀ alkynyl, a C₄-C₃₀ alkynyl, a C₅-C₃₀ alkynyl, a C₆-C₃₀ alkynyl, a C₇-C₃₀ alkynyl, a C₈-C₃₀ alkynyl, a C₉-C₃₀ alkynyl, a C₁₀-C₃₀ alkynyl, a C₁₁-C₃₀ alkynyl, a C₁₂-C₃₀ alkynyl, a C₁₃-C₃₀ alkynyl, a C₁₄-C₃₀ alkynyl, a C₁₅-C₃₀ alkynyl, a C₁₆-C₃₀ alkynyl, a C₁₇-C₃₀ alkynyl, a C₁₈-C₃₀ alkynyl, a C₁₉-C₃₀ alkynyl, a C₂₀-C₃₀ alkynyl, a C₂₁-C₃₀ alkynyl, a C₂₂-C₃₀ alkynyl, a C₂₃-C₃₀ alkynyl, a C₂₄-C₃₀ alkynyl, a C₂₅-C₃₀ alkynyl, a C₂₆-C₃₀ alkynyl, a C₂₇-C₃₀ alkynyl, a C₂₈-C₃₀ alkynyl, a C₂₉-C₃₀ alkynyl, a C₂-C₁₀ alkynyl, a C₃-C₁₀ alkynyl, a C₄-C₁₀ alkynyl, a C₅-C₁₀ alkynyl, a C₆-C₁₀ alkynyl, a C₇-C₁₀ alkynyl, a C₈-C₁₀ alkynyl, a C₂-C₉ alkynyl, a C₂-C₈ alkynyl, a C₂-C₇ alkynyl, a C₂-C₆ alkynyl, a C₂-C₅ alkynyl, a C₃-C₅ alkynyl, or any combination thereof. Examples of alkynyl groups include, without limitation, at least one of ethynyl, propynyl, n-butynyl, n-pentynyl, 3-methyl-1-butynyl, n-hexynyl, methyl-pentynyl, or any combination thereof.

As used herein, the term “cycloalkyl” refers to a non-aromatic carbocyclic ring having from 3 to 8 carbon atoms in the ring. The term includes a monocyclic non-aromatic carbocyclic ring and a polycyclic non-aromatic carbocyclic ring. The term “monocyclic,” when used as a modifier, refers to a cycloalkyl having a single cyclic ring structure. The term “polycyclic,” when used as a modifier, refers to a cycloalkyl having more than one cyclic ring structure, which may be fused, bridged, spiro, or otherwise bonded ring structures. For example, two or more cycloalkyls may be fused, bridged, or fused and bridged to obtain the polycyclic non-aromatic carbocyclic ring. In some embodiments, the cycloalkyl may comprise, consist of, or consist essentially of, or may be selected from the group consisting of, at least one of cyclopropyl, cyclobutyl, cyclopentyl, cyclohexyl, cycloheptyl, cyclooctyl, or any combination thereof.

As used herein, the term “aryl” refers to a monocyclic or polycyclic aromatic hydrocarbon. The number of carbon atoms of the aryl may be in a range of 5 carbon atoms to 100 carbon atoms. In some embodiments, the aryl has 5 to 20 carbon atoms. For example, in some embodiments, the aryl has 6 to 8 carbon atoms, 6 to 10 carbon atoms, 6 to 12 carbon atoms, 6 to 15 carbon atoms, or 6 to 20 carbon atoms. The term “monocyclic,” when used as a modifier, refers to an aryl having a single aromatic ring structure. The term “polycyclic,” when used as a modifier, refers to an aryl having more than one aromatic ring structure, which may be fused, bridged, spiro, or otherwise bonded ring structures. In some embodiments, the aryl is —C₆H₅.

Non-limiting examples of aryls include, without limitation, at least one of phenyl, tolyl, xylyl (e.g., o-xylyl, m-xylyl, p-xylyl), t-butyltolyl, (e.g., o-t-butyltolyl, m-t-butyltolyl, p-t-butyltolyl), ethylmethylphenyl (e.g., 1-ethyl-4-methylphenyl, 1-ethyl-3-methylphenyl), 1-isopropyl-4-methylphenyl, 1-t-butyl-4-methylphenyl, mesitylene, pseudocumene, durene, methylphenyl, dimethylphenyl, trimethylphenyl, ethylphenyl, diethylphenyl (e.g., 1,4-diethylphenyl), triethylphenyl, propylphenyl, butylphenyl, iso-butylphenyl, sec-butylphenyl, t-butylphenyl, hexylphenyl, styrene, naphthyl, anthracenyl, phenanthrene, biphenyl, terphenyl, methylnaphthyl, biphenylene, dimethylnaphthyl, methylanthracenyl, 4,4′-dimethylbiphenyl, diphenylmethane, any isomer thereof, or any combination thereof, and the like.

As used herein, the term “amide” and/or “amine” refers to a functional group of formula —N(R^{a}R^{b}), wherein R^{a} and R^{b} are independently a hydrogen, an alkyl (as defined herein), a carbonyl group, or R^{a} and R^{b} are bonded to each other to form a C₃-C₂₀ N-heterocycle. Amides have the nitrogen adjacent to a C═O group, while amines do not have a carbonyl group; the nitrogen is bonded to carbons or hydrogens.

As used herein, the term “alkoxy” or “alkoxide” refers to a functional group of formula —OR^{c}, wherein R^{c} is an alkyl (as defined herein), a cycloalkyl, or an aryl. In some embodiments, the alkoxy may comprise, consist of, or consist essentially of, or may selected from the group consisting of, at least one of methoxy, ethoxy, n-propoxy, 1-methylethoxy (isopropoxy), n-butoxy, iso-butoxy, sec-butoxy, tert-butoxy, or any combination thereof.

As used herein, the term “halide” refers to a —Cl, —Br, —I, or —F.

As used herein, the term “metal” refers to at least one of an alkali metal, an alkaline earth metal, a transition metal, a post-transition metal, or any combination thereof. In some embodiments, the metal comprises a metal cation. In some embodiments, the metal cation comprises at least one of a lithium cation, a sodium cation, a potassium cation, a rubidium cation, a cesium cation, a francium cation, a beryllium cation, a magnesium cation, a calcium cation, a strontium cation, a barium cation, a radium cation, a scandium cation, a titanium cation, a vanadium cation, a chromium cation, a manganese cation, an iron cation, a cobalt cation, a nickel cation, a copper cation, a zinc cation, a yttrium cation, a zirconium cation, a niobium cation, a molybdenum cation, a technetium cation, a ruthenium cation, a rhodium cation, a palladium cation, a silver cation, a cadmium cation, a hafnium cation, a tantalum cation, a tungsten cation, a rhenium cation, an osmium cation, an iridium cation, a platinum cation, a gold cation, a mercury cation, an aluminum cation, a gallium cation, an indium cation, tin cation, a thallium cation, a lead cation, a bismuth cation, a polonium cation, or any combination thereof. The charge(s) of the metal cations are known and, for simplicity, thus are not repeated here; however, it will be appreciated that the metal cations can have any known charge.

Some embodiments relate to a method of making a precursor comprising at least one of a stannic alkoxide compound, a stannic amide compound, or any combination thereof. The precursors are useful in the manufacture of microelectronic devices. Current synthesis methods involve the use of pyrophoric and corrosive input chemicals, which is undesirable. High purity precursors are desired but current synthesis methods use halides, which results in halide impurities being present in the precursors. Low yields are also a concern with current synthesis methods. Methods provided herein overcome these challenges.

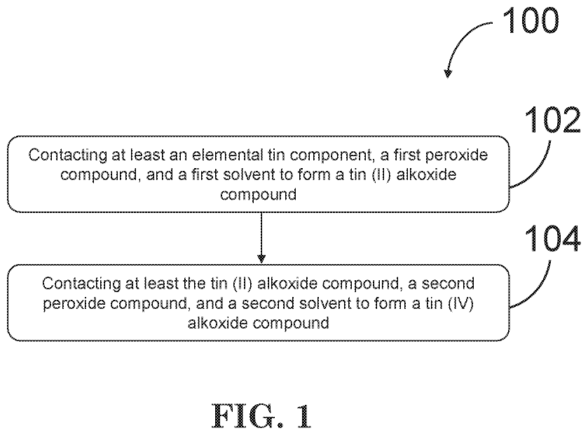

FIG. 1 is a flowchart of a method of making a tin (IV) alkoxide compound 100, according to some embodiments. As shown in FIG. 1, the method of making a tin (IV) alkoxide compound 100 may comprise one or more of the following steps: contacting 102 at least an elemental tin component, a first peroxide compound, and a first solvent to form a tin (II) alkoxide compound; contacting 104 at least the tin (II) alkoxide compound, a second peroxide compound, and a second solvent to form a tin (IV) alkoxide compound.

At step 102, in some embodiments, the method comprises contacting at least an elemental tin component, a first peroxide compound, and a first solvent to form a tin (II) alkoxide compound.

In some embodiments, the first peroxide compound comprises a compound of the formula:

R¹O—OR¹.

In some embodiments, R¹ independently comprises a hydrocarbyl group. In some embodiments, each R¹ is the same. In some embodiments, each R¹ is different. In some embodiments, the first peroxide compound comprises a compound of the formula:

^{t}BuO—OBu^{t},
where ^{t}Bu and Bu^{t} stand for tert-butyl.

In some embodiments, the first solvent comprises an organic solvent. In some embodiments, the organic solvent comprises at least one of hexane, diethyl ether, tetrahydrofuran, toluene, benzene, xylene, dimethoxyethane, 2-methyltetrahydrofuran, or any combination thereof.

In some embodiments, the tin (II) alkoxide compound comprises a compound of the formula:

Sn(OR¹)₂.

In some embodiments, R¹ independently comprises a hydrocarbyl group.

In some embodiments, the contacting proceeds in the presence of a first catalyst. In some embodiments, the first catalyst comprises at least one of a metal halide, a metal oxide, or any combination thereof. In some embodiments, the first catalyst comprises at least one of an iron trichloride, a manganese oxide, a copper (I) chloride, or any combination thereof.

In some embodiments, the contacting comprises mixing the elemental tin, the first peroxide compound, and the first solvent in a first vessel. In some embodiments, the contacting comprises contacting the elemental tin and the first solvent in a first vessel and then adding the first peroxide compound to the first vessel. In some embodiments, the contacting comprises dissolving the elemental tin in the first solvent to form a solution, then contacting the solution with the first peroxide compound.

In some embodiments, the method further comprises heating at least the elemental tin component, the first peroxide compound, and the first solvent. In some embodiments, the heating is performed at a temperature of 30 °C to 150 °C, or any range or subrange between 30 °C to 150 °C. In some embodiments, the heating is performed at a temperature of 30 °C to 140 °C, 30 °C to 130 °C, 30 °C to 120 °C, 30 °C to 110 °C, 30 °C to 100 °C, 30 °C to 90 °C, 30 °C to 80 °C, 30 °C to 70 °C, 30 °C to 60 °C, 30 °C to 50 °C, 30 °C to 40 °C, 40 °C to 150 °C, 50 °C to 150 °C, 60 °C to 150 °C, 70 °C to 150 °C, 80 °C to 150 °C, 90 °C to 150 °C, 100 °C to 150 °C, 110 °C to 150 °C, 120 °C to 150 °C, 130 °C to 150 °C, or 140 °C to 150 °C.

At step 104, in some embodiments, the method comprises contacting at least the tin (II) alkoxide compound, a second peroxide compound, and a second solvent to form a tin (IV) alkoxide compound.

In some embodiments, the second peroxide compound comprises the formula:

R²O—OR².

In some embodiments R² comprises a hydrocarbyl group. In some embodiments, each R² is the same. In some embodiments, each R² is different. In some embodiments, the second peroxide is the same as the first peroxide. In some embodiments, the second peroxide is different from the first peroxide. In some embodiments, at least one R² is the same as at least one R¹. In some embodiments, each R² is the same as each R¹. In some embodiments, each R² is different from each R¹.

In some embodiments, the second solvent comprises an organic solvent. In some embodiments, the organic solvent comprises at least one of hexane, diethyl ether, tetrahydrofuran, toluene, benzene, xylene, dimethoxyethane, 2-methyltetrahydrofuran, or any combination thereof. In some embodiments, the second solvent is the same as the first solvent. In some embodiments, the second solvent is different from the first solvent.

In some embodiments, the contacting proceeds in the presence of a second catalyst. In some embodiments, the second catalyst comprises at least one of a metal halide, a metal oxide, or any combination thereof. In some embodiments, the second catalyst comprises at least one of an iron trichloride, a manganese oxide, a copper (I) chloride, or any combination thereof. In some embodiments, the second catalyst is the same as the first catalyst. In some embodiments, the second catalyst is different from the first catalyst.

In some embodiments, the contacting comprises mixing the tin (II) alkoxide, the second peroxide, and the second solvent in a second vessel. In some embodiments, the second vessel is the same as the first vessel. In some embodiments, the second vessel is different from the first vessel. In some embodiments, the contacting comprises contacting the tin (II) alkoxide and the second solvent in a second vessel and then adding the second peroxide to the second vessel.

In some embodiments, the method further comprises heating at least the tin (II) alkoxide compound, the second peroxide compound, and the second solvent. In some embodiments, the heating is performed at a temperature of 30 °C to 150 °C, or any range or subrange between 30 °C to 150 °C. In some embodiments, the heating is performed at a temperature of 30 °C to 140 °C, 30 °C to 130 °C, 30 °C to 120 °C, 30 °C to 110 °C, 30 °C to 100 °C, 30 °C to 90 °C, 30 °C to 80 °C, 30 °C to 70 °C, 30 °C to 60 °C, 30 °C to 50 °C, 30 °C to 40 °C, 40 °C to 150 °C, 50 °C to 150 °C, 60 °C to 150 °C, 70 °C to 150 °C, 80 °C to 150 °C, 90 °C to 150 °C, 100 °C to 150 °C, 110 °C to 150 °C, 120 °C to 150 °C, 130 °C to 150 °C, or 140 °C to 150 °C.

In some embodiments, the tin (IV) alkoxide compound comprises a compound of the formula:

Sn(OR¹)₂(OR²)₂.

In some embodiments, R¹ and R² independently comprise a hydrocarbyl group. In some embodiments, each R¹ and each R² are the same. In some embodiments, at least one R¹ is the same as at least one R². In some embodiments, each R¹ is different from each R².

In some embodiments, the tin (IV) alkoxide compound comprises a compound of the formula:

Sn(O^{t}Bu)₄,
wherein ^{t}Bu stands for tert-butyl.

In some embodiments, the tin (IV) alkoxide compound comprises less than 1% by weight of a halide based on a total weight of the tin (IV) alkoxide compound. In some embodiments, the tin (IV) alkoxide compound comprises less than 0.9%, less than 0.8%, less than 0.7%, less than 0.6%, less than 0.5%, less than 0.4%, less than 0.3%, less than 0.2%, less than 0.1%, less than 0.09%, less than 0.08%, less than 0.07%, less than 0.06%, less than 0.05%, less than 0.04%, less than 0.03%, less than 0.02%, less than 0.01%, less than 0.009%, less than 0.008%, less than 0.007%, less than 0.006%, less than 0.005%, less than 0.004%, less than 0.003%, less than 0.002%, or less than 0.001% by weight of a halide based on a total weight of the tin (IV) alkoxide compound.

In some embodiments, the tin (IV) alkoxide compound comprises 0.001% to less than 1%, or any range or subrange between 0.001% to less than 1%, by weight of a halide based on a total weight of the tin (IV) alkoxide compound. For example, the tin (IV) alkoxide compound comprises 0.002% to less than 1%, 0.003% to less than 1%, 0.004% to less than 1%, 0.005% to less than 1%, 0.006% to less than 1%, 0.007% to less than 1%, 0.008% to less than 1%, 0.009% to less than 1%, 0.01% to less than 1%, 0.02% to less than 1%, 0.03% to less than 1%, 0.04% to less than 1%, 0.05% to less than 1%, 0.06% to less than 1%, 0.07% to less than 1%, 0.08% to less than 1%, 0.09% to less than 1%, 0.1% to less than 1%, 0.2% to less than 1%, 0.3% to less than 1%, 0.4% to less than 1%, 0.5% to less than 1%, 0.6% to less than 1%, 0.7% to less than 1%, 0.8% to less than 1%, 0.9% to less than 1%, 0.001% to 0.9%, 0.001% to 0.8%, 0.001% to 0.7%, 0.001% to 0.6%, 0.001% to 0.5%, 0.001% to 0.4%, 0.001% to 0.3%, 0.001% to 0.2%, 0.001% to 0.1%, 0.001% to 0.09%, 0.001% to 0.08%, 0.001% to 0.07%, 0.001% to 0.06%, 0.001% to 0.05%, 0.001% to 0.04%, 0.001% to 0.03%, 0.001% to 0.02%, 0.001% to 0.01%, 0.001% to 0.009%, 0.001% to 0.008%, 0.001% to 0.007%, 0.001% to 0.006%, 0.001% to 0.005%, 0.001% to 0.004%, 0.001% to 0.003%, or 0.001% to 0.002% by weight of a halide based on a total weight of the tin (IV) alkoxide compound.

In some embodiments, the tin (IV) alkoxide compound does not comprise a halide.

In some embodiments, the tin (IV) alkoxide compound has a purity of at least 99% as measured by ¹¹⁹Sn-Nuclear Magnetic Resonance (NMR) and ¹H-NMR. In some embodiments, the tin (IV) alkoxide compound has a purity of at least 99.5%, at least 99.9%, at least 99.95%, at least 99.99%, at least 99.995%, at least 99.999% as measured by ¹¹⁹Sn-NMR and ¹H-NMR. In some embodiments, the tin (IV) alkoxide compound has a purity of 99% to 99.999%, or any range or subrange between 99% to 99.999%, as measured by ¹¹⁹Sn-NMR and ¹H-NMR. In some embodiments, the tin (IV) alkoxide compound has a purity of 99% to 99.995%, 99% to 99.99%, 99% to 99.95%, 99% to 99.9%, 99% to 99.5%, 99.5% to 99.999%, 99.9% to 99.999%, 99.95% to 99.999%, 99.99% to 99.999%, or 99.995% to 99.999% as measured by ¹¹⁹Sn-NMR and ¹H-NMR.

In some embodiments, the tin (IV) alkoxide compound has a purity of at least 99% as measured by Inductively Coupled Plasma Mass Spectrometry (ICP-MS). In some embodiments, the tin (IV) alkoxide compound has a purity of at least 99.5%, at least 99.9%, at least 99.95%, at least 99.99%, at least 99.995%, at least 99.999% as measured by ICP-MS. In some embodiments, the tin (IV) alkoxide compound has a purity of 99% to 99.999%, or any range or subrange between 99% to 99.999%, as measured by ICP-MS. In some embodiments, the tin (IV) alkoxide compound has a purity of 99% to 99.995%, 99% to 99.99%, 99% to 99.95%, 99% to 99.9%, 99% to 99.5%, 99.5% to 99.999%, 99.9% to 99.999%, 99.95% to 99.999%, 99.99% to 99.999%, or 99.995% to 99.999% as measured by ICP-MS.

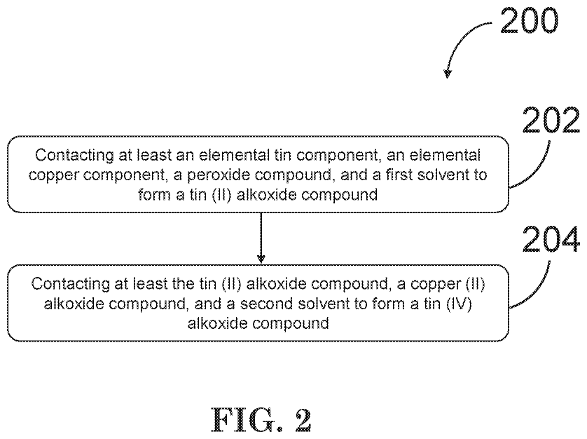

FIG. 2 is a flowchart of a method of making a tin (IV) alkoxide compound 200, according to some embodiments. As shown in FIG. 2, the method of making a tin (IV) alkoxide compound 200 may comprise one or more of the following steps: contacting 202 at least an elemental tin component, an elemental copper component, a peroxide compound, and a first solvent to form a tin (II) alkoxide compound; contacting 204 the tin (II) alkoxide compound, a copper (II) alkoxide compound, and a solvent to form a tin (IV) alkoxide compound.

At step 202, in some embodiments, the method comprises contacting at least an elemental tin component, an elemental copper component, a peroxide compound, and a first solvent to form a tin (II) alkoxide compound.

In some embodiments, the peroxide compound comprises a compound of the formula:

R¹O—OR¹.

In some embodiments, R¹ independently comprises a hydrocarbyl group. In some embodiments, each R¹ is the same. In some embodiments, each R¹ is different. In some embodiments, the peroxide compound comprises a compound of the formula:

^{t}BuO—OBu^{t},
where ^{t}Bu and Bu^{t} stand for tert-butyl.

In some embodiments, the first solvent comprises an organic solvent. In some embodiments, the organic solvent comprises at least one of hexane, diethyl ether, tetrahydrofuran, toluene, benzene, xylene, dimethoxyethane, 2-methyltetrahydrofuran, or any combination thereof.

In some embodiments, the tin (II) alkoxide compound comprises a compound of the formula:

Sn(OR¹)₂.

In some embodiments, R¹ independently comprises a hydrocarbyl group.

In some embodiments, the contacting proceeds in the presence of a first catalyst. In some embodiments, the first catalyst comprises at least one of a metal halide, a metal oxide, or any combination thereof. In some embodiments, the first catalyst comprises at least one of an iron trichloride, a manganese oxide, a copper (I) chloride, or any combination thereof.

In some embodiments, the contacting comprises mixing the elemental tin component, the elemental copper component, the peroxide compound, and the first solvent in a first vessel. In some embodiments, the contacting comprises contacting the elemental tin component, the elemental copper component, and the first solvent in a first vessel and then adding the peroxide compound to the first vessel. In some embodiments, the contacting comprises dissolving the elemental tin component and the elemental copper component in the first solvent to form a solution, then contacting the solution with the peroxide compound.

In some embodiments, the method further comprises heating at least the elemental tin component, the elemental copper component, the peroxide compound, and the first solvent. In some embodiments, the heating is performed at a temperature of 30 °C to 150 °C, or any range or subrange between 30 °C to 150 °C. In some embodiments, the heating is performed at a temperature of 30 °C to 140 °C, 30 °C to 130 °C, 30 °C to 120 °C, 30 °C to 110 °C, 30 °C to 100 °C, 30 °C to 90 °C, 30 °C to 80 °C, 30 °C to 70 °C, 30 °C to 60 °C, 30 °C to 50 °C, 30 °C to 40 °C, 40 °C to 150 °C, 50 °C to 150 °C, 60 °C to 150 °C, 70 °C to 150 °C, 80 °C to 150 °C, 90 °C to 150 °C, 100 °C to 150 °C, 110 °C to 150 °C, 120 °C to 150 °C, 130 °C to 150 °C, or 140 °C to 150 °C.

At step 204, in some embodiments, the method comprises contacting at least the tin (II) alkoxide compound, a copper (II) alkoxide compound, and a second solvent to form a tin (IV) alkoxide compound.

In some embodiments, the copper (II) alkoxide compound comprises at least one of Cu(OR²)₂, Cu(OR²)X, or any combination thereof. In some embodiments, R² independently comprises a hydrocarbyl group. In some embodiments, X comprises a halide.

In some embodiments, each R² is the same. In some embodiments, each R² is different. In some embodiments at least one R² is the same as at least one R¹. In some embodiments, each R² is the same as each R¹. In some embodiments, each R² is different from each R¹.

In some embodiments, Cu(OR²)₂ is formed in step 202. In some embodiments, Cu(OR²)₂ is added in step 204.

In some embodiments, the second solvent comprises an organic solvent. In some embodiments, the organic solvent comprises at least one of hexane, diethyl ether, tetrahydrofuran, toluene, benzene, xylene, dimethoxyethane, 2-methyltetrahydrofuran, or any combination thereof. In some embodiments, the second solvent is the same as the first solvent. In some embodiments, the second solvent is different from the first solvent.

In some embodiments, the contacting proceeds in the presence of a second catalyst. In some embodiments, the second catalyst comprises at least one of a metal halide, a metal oxide, or any combination thereof. In some embodiments, the second catalyst comprises at least one of an iron trichloride, a manganese oxide, a copper (I) chloride, or any combination thereof. In some embodiments, the second catalyst is the same as the first catalyst. In some embodiments, the second catalyst is different from the first catalyst.

In some embodiments, the contacting comprises mixing the tin (II) alkoxide compound, the copper (II) alkoxide compound, and the second solvent in a second vessel. In some embodiments, the second vessel is the same as the first vessel. In some embodiments, the second vessel is different from the first vessel. In some embodiments, the contacting comprises oxidizing the tin (II) alkoxide compound, with the copper (II) alkoxide compound, to form the tin (IV) alkoxide compound.

In some embodiments, the method further comprises heating at least the tin (II) alkoxide compound, the copper (II) alkoxide compound, and the second solvent. In some embodiments, the heating is performed at a temperature of 30 °C to 150 °C, or any range or subrange between 30 °C to 150 °C. In some embodiments, the heating is performed at a temperature of 30 °C to 140 °C, 30 °C to 130 °C, 30 °C to 120 °C, 30 °C to 110 °C, 30 °C to 100 °C, 30 °C to 90 °C, 30 °C to 80 °C, 30 °C to 70 °C, 30 °C to 60 °C, 30 °C to 50 °C, 30 °C to 40 °C, 40 °C to 150 °C, 50 °C to 150 °C, 60 °C to 150 °C, 70 °C to 150 °C, 80 °C to 150 °C, 90 °C to 150 °C, 100 °C to 150 °C, 110 °C to 150 °C, 120 °C to 150 °C, 130 °C to 150 °C, or 140 °C to 150 °C.

In some embodiments, the tin (IV) alkoxide compound comprises a compound of the formula:

Sn(OR¹)₂(OR²)₂.

In some embodiments, R¹ and R² independently comprise a hydrocarbyl group. In some embodiments, each R¹ and each R² are the same. In some embodiments, at least one R¹ is the same as at least one R². In some embodiments, each R¹ is different from each R².

In some embodiments, the tin (IV) alkoxide compound comprises a compound of the formula:

Sn(O^{t}Bu)₄,
wherein ^{t}Bu stands for tert-butyl.

In some embodiments, the tin (IV) alkoxide compound comprises less than 1% by weight of a halide based on a total weight of the tin (IV) alkoxide compound. In some embodiments, the tin (IV) alkoxide compound comprises less than 0.9%, less than 0.8%, less than 0.7%, less than 0.6%, less than 0.5%, less than 0.4%, less than 0.3%, less than 0.2%, less than 0.1%, less than 0.09%, less than 0.08%, less than 0.07%, less than 0.06%, less than 0.05%, less than 0.04%, less than 0.03%, less than 0.02%, less than 0.01%, less than 0.009%, less than 0.008%, less than 0.007%, less than 0.006%, less than 0.005%, less than 0.004%, less than 0.003%, less than 0.002%, or less than 0.001% by weight of a halide based on a total weight of the tin (IV) alkoxide compound.

In some embodiments, the tin (IV) alkoxide compound comprises 0.001% to less than 1%, or any range or subrange between 0.001% to less than 1%, by weight of a halide based on a total weight of the tin (IV) alkoxide compound. For example, the tin (IV) alkoxide compound comprises 0.002% to less than 1%, 0.003% to less than 1%, 0.004% to less than 1%, 0.005% to less than 1%, 0.006% to less than 1%, 0.007% to less than 1%, 0.008% to less than 1%, 0.009% to less than 1%, 0.01% to less than 1%, 0.02% to less than 1%, 0.03% to less than 1%, 0.04% to less than 1%, 0.05% to less than 1%, 0.06% to less than 1%, 0.07% to less than 1%, 0.08% to less than 1%, 0.09% to less than 1%, 0.1% to less than 1%, 0.2% to less than 1%, 0.3% to less than 1%, 0.4% to less than 1%, 0.5% to less than 1%, 0.6% to less than 1%, 0.7% to less than 1%, 0.8% to less than 1%, 0.9% to less than 1%, 0.001% to 0.9%, 0.001% to 0.8%, 0.001% to 0.7%, 0.001% to 0.6%, 0.001% to 0.5%, 0.001% to 0.4%, 0.001% to 0.3%, 0.001% to 0.2%, 0.001% to 0.1%, 0.001% to 0.09%, 0.001% to 0.08%, 0.001% to 0.07%, 0.001% to 0.06%, 0.001% to 0.05%, 0.001% to 0.04%, 0.001% to 0.03%, 0.001% to 0.02%, 0.001% to 0.01%, 0.001% to 0.009%, 0.001% to 0.008%, 0.001% to 0.007%, 0.001% to 0.006%, 0.001% to 0.005%, 0.001% to 0.004%, 0.001% to 0.003%, or 0.001% to 0.002% by weight of a halide based on a total weight of the tin (IV) alkoxide compound.

In some embodiments, the tin (IV) alkoxide compound does not comprise a halide.

In some embodiments, the tin (IV) alkoxide compound has a purity of at least 99% as measured by ¹¹⁹Sn-NMR and ¹H-NMR. In some embodiments, the tin (IV) alkoxide compound has a purity of at least 99.5%, at least 99.9%, at least 99.95%, at least 99.99%, at least 99.995%, at least 99.999% as measured by ¹¹⁹Sn-NMR and ¹H-NMR. In some embodiments, the tin (IV) alkoxide compound has a purity of 99% to 99.999%, or any range or subrange between 99% to 99.999%, as measured by ¹¹⁹Sn-NMR and ¹H-NMR. In some embodiments, the tin (IV) alkoxide compound has a purity of 99% to 99.995%, 99% to 99.99%, 99% to 99.95%, 99% to 99.9%, 99% to 99.5%, 99.5% to 99.999%, 99.9% to 99.999%, 99.95% to 99.999%, 99.99% to 99.999%, or 99.995% to 99.999% as measured by ¹¹⁹Sn-NMR and ¹H-NMR.

In some embodiments, the tin (IV) alkoxide compound has a purity of at least 99% as measured by ICP-MS. In some embodiments, the tin (IV) alkoxide compound has a purity of at least 99.5%, at least 99.9%, at least 99.95%, at least 99.99%, at least 99.995%, at least 99.999% as measured by ICP-MS. In some embodiments, the tin (IV) alkoxide compound has a purity of 99% to 99.999%, or any range or subrange between 99% to 99.999%, as measured by ICP-MS. In some embodiments, the tin (IV) alkoxide compound has a purity of 99% to 99.995%, 99% to 99.99%, 99% to 99.95%, 99% to 99.9%, 99% to 99.5%, 99.5% to 99.999%, 99.9% to 99.999%, 99.95% to 99.999%, 99.99% to 99.999%, or 99.995% to 99.999% as measured by ICP-MS.

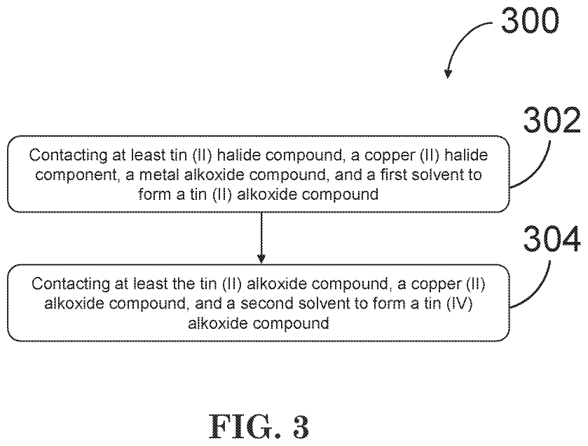

FIG. 3 is a flowchart of a method of making a tin (IV) alkoxide compound 300, according to some embodiments. As shown in FIG. 3, the method of making a tin (IV) alkoxide compound 300 may comprise one or more of the following steps: contacting 302 at least a tin (II) halide compound, a copper halide compound, a metal alkoxide compound, and a first solvent to form a tin (II) alkoxide compound; contacting 304 the tin (II) alkoxide compound, a copper (II) alkoxide compound, and a solvent to form a tin (IV) alkoxide compound.

At step 302, in some embodiments, the method comprises contacting at least a tin (II) halide compound, a copper halide compound, a metal alkoxide compound, and a first solvent to form a tin (II) alkoxide compound.

In some embodiments, the tin (II) halide compound comprises a compound of the formula:

SnX₂.

In some embodiments, X independently comprises a halide.

In some embodiments, the copper (II) halide compound comprises a compound of the formula:

CuX₂.

In some embodiments, X independently comprises a halide.

In some embodiments, the metal alkoxide compound comprises a compound of the formula:

MOR¹.

In some embodiments, M comprises at least one of an alkali metal, an alkaline earth metal, a transition metal, or any combination thereof. In some embodiments, R¹ independently comprises a hydrocarbyl group.

In some embodiments, the metal alkoxide compound comprises a compound of the formula:

KO^{t}Bu,
where ^{t}Bu stands for tert-butyl.

In some embodiments, the metal alkoxide compound comprises a compound of the formula:

LiO^{t}Bu,
where ^{t}Bu stands for tert-butyl.

In some embodiments, the first solvent comprises an organic solvent. In some embodiments, the organic solvent comprises at least one of hexane, diethyl ether, tetrahydrofuran, toluene, benzene, xylene, dimethoxyethane, 2-methyltetrahydrofuran, or any combination thereof.

In some embodiments, the tin (II) alkoxide compound comprises a compound of the formula:

Sn(OR¹)₂.

In some embodiments, R¹ independently comprises a hydrocarbyl group.

In some embodiments, the contacting proceeds in the presence of a first catalyst. In some embodiments, the first catalyst comprises at least one of a metal halide, a metal oxide, or any combination thereof. In some embodiments, the first catalyst comprises at least one of an iron trichloride, a manganese oxide, a copper (I) chloride, or any combination thereof.

In some embodiments, the contacting comprises mixing the tin (II) halide compound, the copper (II) halide compound, the metal alkoxide compound, and the first solvent in a first vessel. In some embodiments, the contacting comprises contacting the tin (II) halide compound, the copper (II) halide compound, and the first solvent in a first vessel and then adding the metal alkoxide compound to the first vessel.

In some embodiments, the method further comprises heating at least the tin (II) halide compound, the copper (II) halide compound, the metal alkoxide compound, and the first solvent. In some embodiments, the heating is performed at a temperature of 30 °C to 150 °C, or any range or subrange between 30 °C to 150 °C. In some embodiments, the heating is performed at a temperature of 30 °C to 140 °C, 30 °C to 130 °C, 30 °C to 120 °C, 30 °C to 110 °C, 30 °C to 100 °C, 30 °C to 90 °C, 30 °C to 80 °C, 30 °C to 70 °C, 30 °C to 60 °C, 30 °C to 50 °C, 30 °C to 40 °C, 40 °C to 150 °C, 50 °C to 150 °C, 60 °C to 150 °C, 70 °C to 150 °C, 80 °C to 150 °C, 90 °C to 150 °C, 100 °C to 150 °C, 110 °C to 150 °C, 120 °C to 150 °C, 130 °C to 150 °C, or 140 °C to 150 °C.

At step 304, in some embodiments, the method comprises contacting at least the tin (II) alkoxide compound, a copper (II) alkoxide compound, and a second solvent to form a tin (IV) alkoxide compound.

In some embodiments, the copper (II) alkoxide compound comprises at least one of Cu(OR²)₂, Cu(OR²)X, or any combination thereof. In some embodiments, R² independently comprises a hydrocarbyl group. In some embodiments, X comprises a halide.

In some embodiments, each R² is the same. In some embodiments, each R² is different. In some embodiments at least one R² is the same as at least one R¹. In some embodiments, each R² is the same as each R¹. In some embodiments, each R² is different from each R¹.

In some embodiments, Cu(OR²)₂ is formed in step 302. In some embodiments, Cu(OR²)₂ is added in step 304.

In some embodiments, the copper (II) alkoxide compound comprises a copper (II) halide/alkoxide/metal complex. In some embodiments, the copper (II) halide/alkoxide/metal complex is formed in step 302. In some embodiments, the copper (II) halide/alkoxide/metal complex comprises a compound of the formula:

Li₂Cu(Cl)₂(O^{t}Bu)₂,
where ^{t}Bu stands for tert-butyl.

In some embodiments, the second solvent comprises an organic solvent. In some embodiments, the organic solvent comprises at least one of hexane, diethyl ether, tetrahydrofuran, toluene, benzene, xylene, dimethoxyethane, 2-methyltetrahydrofuran, or any combination thereof. In some embodiments, the second solvent is the same as the first solvent. In some embodiments, the second solvent is different from the first solvent.

In some embodiments, the contacting proceeds in the presence of a second catalyst. In some embodiments, the second catalyst comprises at least one of a metal halide, a metal oxide, or any combination thereof. In some embodiments, the second catalyst comprises at least one of an iron trichloride, a manganese oxide, a copper (I) chloride, or any combination thereof. In some embodiments, the second catalyst is the same as the first catalyst. In some embodiments, the second catalyst is different from the first catalyst.

In some embodiments, the contacting comprises mixing the tin (II) alkoxide compound, the copper (II) alkoxide compound, and the second solvent in a second vessel. In some embodiments, the second vessel is the same as the first vessel. In some embodiments, the second vessel is different from the first vessel. In some embodiments, the contacting comprises oxidizing the tin (II) alkoxide compound, with the copper (II) alkoxide compound, to form the tin (IV) alkoxide compound.

In some embodiments, the method further comprises heating at least the tin (II) alkoxide compound, the copper (II) alkoxide compound, and the second solvent. In some embodiments, the heating is performed at a temperature of 30 °C to 150 °C, or any range or subrange between 30 °C to 150 °C. In some embodiments, the heating is performed at a temperature of 30 °C to 140 °C, 30 °C to 130 °C, 30 °C to 120 °C, 30 °C to 110 °C, 30 °C to 100 °C, 30 °C to 90 °C, 30 °C to 80 °C, 30 °C to 70 °C, 30 °C to 60 °C, 30 °C to 50 °C, 30 °C to 40 °C, 40 °C to 150 °C, 50 °C to 150 °C, 60 °C to 150 °C, 70 °C to 150 °C, 80 °C to 150 °C, 90 °C to 150 °C, 100 °C to 150 °C, 110 °C to 150 °C, 120 °C to 150 °C, 130 °C to 150 °C, or 140 °C to 150 °C.

In some embodiments, the tin (IV) alkoxide compound comprises a compound of the formula:

Sn(OR¹)₂(OR²)₂.

In some embodiments, R¹ and R² independently comprise a hydrocarbyl group. In some embodiments, each R¹ and each R² are the same. In some embodiments, at least one R¹ is the same as at least one R². In some embodiments, each R¹ is different from each R².

In some embodiments, the tin (IV) alkoxide compound comprises a compound of the formula:

Sn(O^{t}Bu)₄,
wherein ^{t}Bu stands for tert-butyl.

In some embodiments, the tin (IV) alkoxide compound comprises less than 1% by weight of a halide based on a total weight of the tin (IV) alkoxide compound. In some embodiments, the tin (IV) alkoxide compound comprises less than 0.9%, less than 0.8%, less than 0.7%, less than 0.6%, less than 0.5%, less than 0.4%, less than 0.3%, less than 0.2%, less than 0.1%, less than 0.09%, less than 0.08%, less than 0.07%, less than 0.06%, less than 0.05%, less than 0.04%, less than 0.03%, less than 0.02%, less than 0.01%, less than 0.009%, less than 0.008%, less than 0.007%, less than 0.006%, less than 0.005%, less than 0.004%, less than 0.003%, less than 0.002%, or less than 0.001% by weight of a halide based on a total weight of the tin (IV) alkoxide compound.

In some embodiments, the tin (IV) alkoxide compound comprises 0.001% to less than 1%, or any range or subrange between 0.001% to less than 1%, by weight of a halide based on a total weight of the tin (IV) alkoxide compound. For example, the tin (IV) alkoxide compound comprises 0.002% to less than 1%, 0.003% to less than 1%, 0.004% to less than 1%, 0.005% to less than 1%, 0.006% to less than 1%, 0.007% to less than 1%, 0.008% to less than 1%, 0.009% to less than 1%, 0.01% to less than 1%, 0.02% to less than 1%, 0.03% to less than 1%, 0.04% to less than 1%, 0.05% to less than 1%, 0.06% to less than 1%, 0.07% to less than 1%, 0.08% to less than 1%, 0.09% to less than 1%, 0.1% to less than 1%, 0.2% to less than 1%, 0.3% to less than 1%, 0.4% to less than 1%, 0.5% to less than 1%, 0.6% to less than 1%, 0.7% to less than 1%, 0.8% to less than 1%, 0.9% to less than 1%, 0.001% to 0.9%, 0.001% to 0.8%, 0.001% to 0.7%, 0.001% to 0.6%, 0.001% to 0.5%, 0.001% to 0.4%, 0.001% to 0.3%, 0.001% to 0.2%, 0.001% to 0.1%, 0.001% to 0.09%, 0.001% to 0.08%, 0.001% to 0.07%, 0.001% to 0.06%, 0.001% to 0.05%, 0.001% to 0.04%, 0.001% to 0.03%, 0.001% to 0.02%, 0.001% to 0.01%, 0.001% to 0.009%, 0.001% to 0.008%, 0.001% to 0.007%, 0.001% to 0.006%, 0.001% to 0.005%, 0.001% to 0.004%, 0.001% to 0.003%, or 0.001% to 0.002% by weight of a halide based on a total weight of the tin (IV) alkoxide compound.

In some embodiments, the tin (IV) alkoxide compound does not comprise a halide.

In some embodiments, the tin (IV) alkoxide compound has a purity of at least 99% as measured by ¹¹⁹Sn-NMR and ¹H-NMR. In some embodiments, the tin (IV) alkoxide compound has a purity of at least 99.5%, at least 99.9%, at least 99.95%, at least 99.99%, at least 99.995%, at least 99.999% as measured by ¹¹⁹Sn-NMR and ¹H-NMR. In some embodiments, the tin (IV) alkoxide compound has a purity of 99% to 99.999%, or any range or subrange between 99% to 99.999%, as measured by ¹¹⁹Sn-NMR and ¹H-NMR. In some embodiments, the tin (IV) alkoxide compound has a purity of 99% to 99.995%, 99% to 99.99%, 99% to 99.95%, 99% to 99.9%, 99% to 99.5%, 99.5% to 99.999%, 99.9% to 99.999%, 99.95% to 99.999%, 99.99% to 99.999%, or 99.995% to 99.999% as measured by ¹¹⁹Sn-NMR and ¹H-NMR.

In some embodiments, the tin (IV) alkoxide compound has a purity of at least 99% as measured by ICP-MS. In some embodiments, the tin (IV) alkoxide compound has a purity of at least 99.5%, at least 99.9%, at least 99.95%, at least 99.99%, at least 99.995%, at least 99.999% as measured by ICP-MS. In some embodiments, the tin (IV) alkoxide compound has a purity of 99% to 99.999%, or any range or subrange between 99% to 99.999%, as measured by ICP-MS. In some embodiments, the tin (IV) alkoxide compound has a purity of 99% to 99.995%, 99% to 99.99%, 99% to 99.95%, 99% to 99.9%, 99% to 99.5%, 99.5% to 99.999%, 99.9% to 99.999%, 99.95% to 99.999%, 99.99% to 99.999%, or 99.995% to 99.999% as measured by ICP-MS.

Some embodiments relate to a method. In some embodiments, the method comprises contacting at least a tin (II) amide compound, a copper (II) amide compound, and a solvent to form a tin (IV) amide compound.

In some embodiments, the tin (II) amide compound comprises a compound of the formula:

Sn(NR¹₂)₂.

In some embodiments, R¹ independently comprises a hydrocarbyl group. In some embodiments, each R¹ is the same. In some embodiments, each R¹ is different. In some embodiments, at least one R¹ is different.

In some embodiments, the copper (II) amide compound comprises at least one of Cu(NR²₂)₂, Cu(NR²₂)X, or any combination thereof. In some embodiments, R² independently comprises a hydrocarbyl group. In some embodiments, X comprises a halide.

In some embodiments, each R² is the same. In some embodiments, each R² is different. In some embodiments, at least one R² is different. In some embodiments, each R² is the same as each R¹. In some embodiments, each R² is different from each R¹. In some embodiments, at least one R² is the same as at least one R¹. In some embodiments, at least one R² is different from at least one R¹.

In some embodiments, the solvent comprises an organic solvent. In some embodiments, the organic solvent comprises at least one of hexane, diethyl ether, tetrahydrofuran, toluene, benzene, xylene, dimethoxyethane, 2-methyltetrahydrofuran, or any combination thereof.

In some embodiments, the contacting proceeds in the presence of a catalyst. In some embodiments, the catalyst comprises at least one of a metal halide, a metal oxide, or any combination thereof. In some embodiments, the catalyst comprises at least one of an iron trichloride, a manganese oxide, a copper (I) chloride, or any combination thereof.

In some embodiments, the contacting comprises mixing the tin (II) amide compound, the copper (II) amide compound, and the solvent in a vessel. In some embodiments, the contacting comprises oxidizing the tin (II) amide compound, with the copper (II) amide compound, to form the tin (IV) amide compound.

In some embodiments, the method further comprises heating at least the tin (II) amide compound, the copper (II) amide compound, and the solvent. In some embodiments, the heating is performed at a temperature of 30 °C to 150 °C, or any range or subrange between 30 °C to 150 °C. In some embodiments, the heating is performed at a temperature of 30 °C to 140 °C, 30 °C to 130 °C, 30 °C to 120 °C, 30 °C to 110 °C, 30 °C to 100 °C, 30 °C to 90 °C, 30 °C to 80 °C, 30 °C to 70 °C, 30 °C to 60 °C, 30 °C to 50 °C, 30 °C to 40 °C, 40 °C to 150 °C, 50 °C to 150 °C, 60 °C to 150 °C, 70 °C to 150 °C, 80 °C to 150 °C, 90 °C to 150 °C, 100 °C to 150 °C, 110 °C to 150 °C, 120 °C to 150 °C, 130 °C to 150 °C, or 140 °C to 150 °C.

In some embodiments, the tin (IV) amide compound comprises a compound of the formula:

Sn(NR¹₂)₂(NR²₂)₂.

In some embodiments, R¹ and R² independently comprise a hydrocarbyl group. In some embodiments, each R¹ and each R² are the same. In some embodiments, at least one R¹ is the same as at least one R². In some embodiments, each R¹ is different from each R².

In some embodiments, the tin (IV) amide compound comprises a compound of the formula:

Sn(NMe₂)₄,
wherein Me stands for methyl.

In some embodiments, the tin (IV) amide compound comprises less than 1% by weight of a halide based on a total weight of the tin (IV) amide compound. In some embodiments, the tin (IV) amide compound comprises less than 0.9%, less than 0.8%, less than 0.7%, less than 0.6%, less than 0.5%, less than 0.4%, less than 0.3%, less than 0.2%, less than 0.1%, less than 0.09%, less than 0.08%, less than 0.07%, less than 0.06%, less than 0.05%, less than 0.04%, less than 0.03%, less than 0.02%, less than 0.01%, less than 0.009%, less than 0.008%, less than 0.007%, less than 0.006%, less than 0.005%, less than 0.004%, less than 0.003%, less than 0.002%, or less than 0.001% by weight of a halide based on a total weight of the tin (IV) amide compound.

In some embodiments, the tin (IV) amide compound comprises 0.001% to less than 1%, or any range or subrange between 0.001% to less than 1%, by weight of a halide based on a total weight of the tin (IV) amide compound. For example, the tin (IV) amide compound comprises 0.002% to less than 1%, 0.003% to less than 1%, 0.004% to less than 1%, 0.005% to less than 1%, 0.006% to less than 1%, 0.007% to less than 1%, 0.008% to less than 1%, 0.009% to less than 1%, 0.01% to less than 1%, 0.02% to less than 1%, 0.03% to less than 1%, 0.04% to less than 1%, 0.05% to less than 1%, 0.06% to less than 1%, 0.07% to less than 1%, 0.08% to less than 1%, 0.09% to less than 1%, 0.1% to less than 1%, 0.2% to less than 1%, 0.3% to less than 1%, 0.4% to less than 1%, 0.5% to less than 1%, 0.6% to less than 1%, 0.7% to less than 1%, 0.8% to less than 1%, 0.9% to less than 1%, 0.001% to 0.9%, 0.001% to 0.8%, 0.001% to 0.7%, 0.001% to 0.6%, 0.001% to 0.5%, 0.001% to 0.4%, 0.001% to 0.3%, 0.001% to 0.2%, 0.001% to 0.1%, 0.001% to 0.09%, 0.001% to 0.08%, 0.001% to 0.07%, 0.001% to 0.06%, 0.001% to 0.05%, 0.001% to 0.04%, 0.001% to 0.03%, 0.001% to 0.02%, 0.001% to 0.01%, 0.001% to 0.009%, 0.001% to 0.008%, 0.001% to 0.007%, 0.001% to 0.006%, 0.001% to 0.005%, 0.001% to 0.004%, 0.001% to 0.003%, or 0.001% to 0.002% by weight of a halide based on a total weight of the tin (IV) amide compound.

In some embodiments, the tin (IV) amide compound does not comprise a halide.

In some embodiments, the tin (IV) amide compound has a purity of at least 99% as measured by ¹¹⁹Sn-NMR and ¹H-NMR. In some embodiments, the tin (IV) amide compound has a purity of at least 99.5%, at least 99.9%, at least 99.95%, at least 99.99%, at least 99.995%, at least 99.999% as measured by ¹¹⁹Sn-NMR and ¹H-NMR. In some embodiments, the tin (IV) amide compound has a purity of 99% to 99.999%, or any range or subrange between 99% to 99.999%, as measured by ¹¹⁹Sn-NMR and ¹H-NMR. In some embodiments, the tin (IV) amide compound has a purity of 99% to 99.995%, 99% to 99.99%, 99% to 99.95%, 99% to 99.9%, 99% to 99.5%, 99.5% to 99.999%, 99.9% to 99.999%, 99.95% to 99.999%, 99.99% to 99.999%, or 99.995% to 99.999% as measured by ¹¹⁹Sn-NMR and ¹H-NMR.

In some embodiments, the tin (IV) amide compound has a purity of at least 99% as measured by ICP-MS. In some embodiments, the tin (IV) amide compound has a purity of at least 99.5%, at least 99.9%, at least 99.95%, at least 99.99%, at least 99.995%, at least 99.999% as measured by ICP-MS. In some embodiments, the tin (IV) amide compound has a purity of 99% to 99.999%, or any range or subrange between 99% to 99.999%, as measured by ICP-MS. In some embodiments, the tin (IV) amide compound has a purity of 99% to 99.995%, 99% to 99.99%, 99% to 99.95%, 99% to 99.9%, 99% to 99.5%, 99.5% to 99.999%, 99.9% to 99.999%, 99.95% to 99.999%, 99.99% to 99.999%, or 99.995% to 99.999% as measured by ICP-MS.

Some embodiments relate to a method. In some embodiments, the method comprises contacting at least a copper (II) compound, a metal amide compound, and a solvent to form a copper (II) amide compound.

In some embodiments, the copper (II) compound comprises a compound of the formula:

CuY₂.

In some embodiments, Y independently comprises at least one of a halide, a sulfate, an acetate, an oxalate, an acetylacetonate, a nitrate, or any combination thereof. In some embodiments, each Y is the same. In some embodiments, each Y is different.

In some embodiments, the metal amide compound comprises a compound of the formula:

M(NR¹₂)ₙ.

In some embodiments, M comprises at least one of an alkali metal, an alkaline earth metal, or any combination thereof. In some embodiments, R¹ independently comprises a hydrocarbyl group. In some embodiments, each R¹ is the same. In some embodiments, each R¹ is different. In some embodiments, n is 1 or 2.

In some embodiments, the copper (II) amide compound comprises a compound of the formula:

Cu(NR¹₂)₂.

In some embodiments, R¹ independently comprises a hydrocarbyl group. In some embodiments, each R¹ is the same. In some embodiments, each R¹ is different. In some embodiments, at least one R¹ differs from the others.

In some embodiments, the solvent comprises an organic solvent. In some embodiments, the organic solvent comprises at least one of hexane, diethyl ether, tetrahydrofuran, toluene, benzene, xylene, dimethoxyethane, 2-methyltetrahydrofuran, or any combination thereof.

In some embodiments, the contacting comprises mixing the copper (II) compound, the metal amide compound, and the solvent in a vessel. In some embodiments, the contacting comprises contacting at a temperature of −100 °C to 10 °C, or any range or subrange between −100 °C to 10 °C. For example, in some embodiments, the contacting comprises contacting at a temperature of −100 °C to 0 °C, −100 °C to −10 °C, −100 °C to −20 °C, −100 °C to −30 °C, −100 °C to −40 °C, −100 °C to −50 °C, −100 °C to −60 °C, −100 °C to −70 °C, −100 °C to −80 °C, −100 °C to −90 °C, −90 °C to 10 °C, −80 °C to 10 °C, −70 °C to 10 °C, −60 °C to 10 °C, −50 °C to 10 °C, −40 °C to 10 °C, −30 °C to 10 °C, −20 °C to 10 °C, −10 °C to 10 °C, or 0 °C to 10 °C.

Some embodiments relate to a composition. In some embodiments, the composition comprises a tin (IV) alkoxide compound. In some embodiments, the composition comprises less than 1% by weight of a halide based on a total weight of the composition.

In some embodiments, the tin (IV) alkoxide compound comprises a compound of the formula:

Sn(OR)₄.

In some embodiments, R independently comprises a hydrocarbyl group. In some embodiments, each R is the same. In some embodiments, each R is different. In some embodiments, at least one R is different.

In some embodiments, the tin (IV) alkoxide compound comprises a compound of the formula:

Sn(O^{t}Bu)₄,
wherein ^{t}Bu stands for tert-butyl.

In some embodiments, the composition comprises less than 1% by weight of a halide based on a total weight of the composition. In some embodiments, the composition comprises less than 0.9%, less than 0.8%, less than 0.7%, less than 0.6%, less than 0.5%, less than 0.4%, less than 0.3%, less than 0.2%, less than 0.1%, less than 0.09%, less than 0.08%, less than 0.07%, less than 0.06%, less than 0.05%, less than 0.04%, less than 0.03%, less than 0.02%, less than 0.01%, less than 0.009%, less than 0.008%, less than 0.007%, less than 0.006%, less than 0.005%, less than 0.004%, less than 0.003%, less than 0.002%, or less than 0.001% by weight of a halide based on a total weight of the composition.

In some embodiments, the composition comprises 0.001% to less than 1%, or any range or subrange between 0.001% to less than 1%, by weight of a halide based on a total weight of the composition. For example, the composition comprises 0.002% to less than 1%, 0.003% to less than 1%, 0.004% to less than 1%, 0.005% to less than 1%, 0.006% to less than 1%, 0.007% to less than 1%, 0.008% to less than 1%, 0.009% to less than 1%, 0.01% to less than 1%, 0.02% to less than 1%, 0.03% to less than 1%, 0.04% to less than 1%, 0.05% to less than 1%, 0.06% to less than 1%, 0.07% to less than 1%, 0.08% to less than 1%, 0.09% to less than 1%, 0.1% to less than 1%, 0.2% to less than 1%, 0.3% to less than 1%, 0.4% to less than 1%, 0.5% to less than 1%, 0.6% to less than 1%, 0.7% to less than 1%, 0.8% to less than 1%, 0.9% to less than 1%, 0.001% to 0.9%, 0.001% to 0.8%, 0.001% to 0.7%, 0.001% to 0.6%, 0.001% to 0.5%, 0.001% to 0.4%, 0.001% to 0.3%, 0.001% to 0.2%, 0.001% to 0.1%, 0.001% to 0.09%, 0.001% to 0.08%, 0.001% to 0.07%, 0.001% to 0.06%, 0.001% to 0.05%, 0.001% to 0.04%, 0.001% to 0.03%, 0.001% to 0.02%, 0.001% to 0.01%, 0.001% to 0.009%, 0.001% to 0.008%, 0.001% to 0.007%, 0.001% to 0.006%, 0.001% to 0.005%, 0.001% to 0.004%, 0.001% to 0.003%, or 0.001% to 0.002% by weight of a halide based on a total weight of the composition.

In some embodiments, the composition does not comprise a halide.

In some embodiments, the tin (IV) alkoxide compound has a purity of at least 99% as measured by ¹¹⁹Sn-NMR and ¹H-NMR. In some embodiments, the tin (IV) alkoxide compound has a purity of at least 99.5%, at least 99.9%, at least 99.95%, at least 99.99%, at least 99.995%, at least 99.999% as measured by ¹¹⁹Sn-NMR and ¹H-NMR. In some embodiments, the tin (IV) alkoxide compound has a purity of 99% to 99.999%, or any range or subrange between 99% to 99.999%, as measured by ¹¹⁹Sn-NMR and ¹H-NMR. In some embodiments, the tin (IV) alkoxide compound has a purity of 99% to 99.995%, 99% to 99.99%, 99% to 99.95%, 99% to 99.9%, 99% to 99.5%, 99.5% to 99.999%, 99.9% to 99.999%, 99.95% to 99.999%, 99.99% to 99.999%, or 99.995% to 99.999% as measured by ¹¹⁹Sn-NMR and ¹H-NMR.

In some embodiments, the tin (IV) alkoxide compound has a purity of at least 99% as measured by ICP-MS. In some embodiments, the tin (IV) alkoxide compound has a purity of at least 99.5%, at least 99.9%, at least 99.95%, at least 99.99%, at least 99.995%, at least 99.999% as measured by ICP-MS. In some embodiments, the tin (IV) alkoxide compound has a purity of 99% to 99.999%, or any range or subrange between 99% to 99.999%, as measured by ICP-MS. In some embodiments, the tin (IV) alkoxide compound has a purity of 99% to 99.995%, 99% to 99.99%, 99% to 99.95%, 99% to 99.9%, 99% to 99.5%, 99.5% to 99.999%, 99.9% to 99.999%, 99.95% to 99.999%, 99.99% to 99.999%, or 99.995% to 99.999% as measured by ICP-MS.

Some embodiments relate to a composition. In some embodiments, the composition comprises a tin (IV) amide compound. In some embodiments, the composition comprises less than 1% by weight of a halide based on a total weight of the composition.

In some embodiments, the tin (IV) amide compound comprises a compound of the formula:

Sn(NR²)₄.

In some embodiments, R independently comprises a hydrocarbyl group. In some embodiments, each R is the same. In some embodiments, each R is different. In some embodiments, at least one R is different.

In some embodiments, the tin (IV) amide compound comprises a compound of the formula:

Sn(NMe₂)₄,
wherein Me stands for methyl.

In some embodiments, the composition comprises less than 1% by weight of a halide based on a total weight of the composition. In some embodiments, the composition comprises less than 0.9%, less than 0.8%, less than 0.7%, less than 0.6%, less than 0.5%, less than 0.4%, less than 0.3%, less than 0.2%, less than 0.1%, less than 0.09%, less than 0.08%, less than 0.07%, less than 0.06%, less than 0.05%, less than 0.04%, less than 0.03%, less than 0.02%, less than 0.01%, less than 0.009%, less than 0.008%, less than 0.007%, less than 0.006%, less than 0.005%, less than 0.004%, less than 0.003%, less than 0.002%, or less than 0.001% by weight of a halide based on a total weight of the composition.

In some embodiments, the composition comprises 0.001% to less than 1%, or any range or subrange between 0.001% to less than 1%, by weight of a halide based on a total weight of the composition. For example, the composition comprises 0.002% to less than 1%, 0.003% to less than 1%, 0.004% to less than 1%, 0.005% to less than 1%, 0.006% to less than 1%, 0.007% to less than 1%, 0.008% to less than 1%, 0.009% to less than 1%, 0.01% to less than 1%, 0.02% to less than 1%, 0.03% to less than 1%, 0.04% to less than 1%, 0.05% to less than 1%, 0.06% to less than 1%, 0.07% to less than 1%, 0.08% to less than 1%, 0.09% to less than 1%, 0.1% to less than 1%, 0.2% to less than 1%, 0.3% to less than 1%, 0.4% to less than 1%, 0.5% to less than 1%, 0.6% to less than 1%, 0.7% to less than 1%, 0.8% to less than 1%, 0.9% to less than 1%, 0.001% to 0.9%, 0.001% to 0.8%, 0.001% to 0.7%, 0.001% to 0.6%, 0.001% to 0.5%, 0.001% to 0.4%, 0.001% to 0.3%, 0.001% to 0.2%, 0.001% to 0.1%, 0.001% to 0.09%, 0.001% to 0.08%, 0.001% to 0.07%, 0.001% to 0.06%, 0.001% to 0.05%, 0.001% to 0.04%, 0.001% to 0.03%, 0.001% to 0.02%, 0.001% to 0.01%, 0.001% to 0.009%, 0.001% to 0.008%, 0.001% to 0.007%, 0.001% to 0.006%, 0.001% to 0.005%, 0.001% to 0.004%, 0.001% to 0.003%, or 0.001% to 0.002% by weight of a halide based on a total weight of the composition.

In some embodiments, the composition does not comprise a halide.

In some embodiments, the tin (IV) amide compound has a purity of at least 99% as measured by ¹¹⁹Sn-NMR and ¹H-NMR. In some embodiments, the tin (IV) amide compound has a purity of at least 99.5%, at least 99.9%, at least 99.95%, at least 99.99%, at least 99.995%, at least 99.999% as measured by ¹¹⁹Sn-NMR and ¹H-NMR. In some embodiments, the tin (IV) amide compound has a purity of 99% to 99.999%, or any range or subrange between 99% to 99.999%, as measured by ¹¹⁹Sn-NMR and ¹H-NMR. In some embodiments, the tin (IV) amide compound has a purity of 99% to 99.995%, 99% to 99.99%, 99% to 99.95%, 99% to 99.9%, 99% to 99.5%, 99.5% to 99.999%, 99.9% to 99.999%, 99.95% to 99.999%, 99.99% to 99.999%, or 99.995% to 99.999% as measured by ¹¹⁹Sn-NMR and ¹H-NMR.

In some embodiments, the tin (IV) amide compound has a purity of at least 99% as measured by ICP-MS. In some embodiments, the tin (IV) amide compound has a purity of at least 99.5%, at least 99.9%, at least 99.95%, at least 99.99%, at least 99.995%, at least 99.999% as measured by ICP-MS. In some embodiments, the tin (IV) amide compound has a purity of 99% to 99.999%, or any range or subrange between 99% to 99.999%, as measured by ICP-MS. In some embodiments, the tin (IV) amide compound has a purity of 99% to 99.995%, 99% to 99.99%, 99% to 99.95%, 99% to 99.9%, 99% to 99.5%, 99.5% to 99.999%, 99.9% to 99.999%, 99.95% to 99.999%, 99.99% to 99.999%, or 99.995% to 99.999% as measured by ICP-MS.

Any one or more of the embodiments disclosed herein shall be understood to be combinable without departing from the scope or spirit of the disclosure.

### Example 1

In a nitrogen-filled glovebox, [Sn(O^{t}Bu)₂]₂ (1.00 g, 1.89 mmol) was placed in a clear 40 mL vial and dissolved in toluene (5 mL) to form a Sn alkoxide solution. Separately, di-tert-butylperoxide (0.52 g, 3.77 mmol) was massed in a vial and diluted with toluene (2 mL) to form a peroxide solution. The peroxide solution was added directly to the Sn alkoxide solution, resulting in a clear solution. The reaction was heated to 110 °C for 1 hour, whereby, the colorless solution was cooled to room temperature and an aliquot of the colorless solution was analyzed by ¹H-NMR and ¹¹⁹Sn-NMR. The target species (Sn(O^{t}Bu)₄) was present in 2% by ¹¹⁹Sn-NMR (−371 ppm). The reaction was heated at 110 °C for an additional 12 hours, where a subsequent aliquot of the slightly amber solution was collected and submitted for analysis by NMR (¹H and ¹¹⁹Sn). The Sn(O^{t}Bu)₄ concentration increased to 15% abundance. At this point, FeCl₃ (0.02 g, 0.123 mmol) was added to the reaction and the mixture reheated to 110 °C for 12 hours. An aliquot was collected from the reaction mixture, which presented with an enhanced yellow color as compared to the previous aliquot and submitted for analysis by NMR. One species was present by ¹¹⁹Sn-NMR at −371 ppm and is assigned as the target molecule, (Sn(O^{t}Bu)₄, representing complete conversion to the desired product.

### Example 2

In a nitrogen-filled glovebox, KO^{t}Bu (1.69 g, 15.0 mmol), SnCl₂ (0.71 g, 3.72 mmol), and CuCl₂ (1.00 g, 7.44 mmol) were combined in a 40 mL clear vial equipped with a magnetic stir bar and diluted with 20 ml of tetrahydrofuran (THF), resulting in an exotherm and the presence of a dark green mixture. The reaction was stirred at 65 °C, whereby after 20 minutes the reaction had changed to a dark tan/mustard colored mixture. After 12 hours, the reaction presented as a tan mixture with an amber mother liquor. The mixture was filtered through a disposable polyethylene filter frit, the filter cake washed with 5 mL of THF, and the combined organics dried under reduced pressure to yield Sn(O^{t}Bu)₄ as an off-white solid. 1.03 g (67.3%) of Sn(O^{t}Bu)₄ was isolated. ¹H-NMR and ¹¹⁹Sn-NMR collected on a CDCl₃ solution of the product are consistent with the synthesis of the target molecule (−371 ppm by ¹¹⁹Sn NMR).

### Example 3

In a nitrogen-filled glovebox, anhydrous CuCl₂ (35.45 g, 263.7 mmol) was placed in a 500 mL round bottom flask equipped with a magnetic stir bar and diluted with THF (125 mL) to form a thick red/orange suspension. LiO^{t}Bu (21.32 g, 266.35 mmol) was added to the stirred suspension over the course of 10 minutes, whereby, each aliquot resulted in a mild exotherm and the reaction presented as a dark green solution upon complete addition. In a separate 250 mL round bottom flask equipped with a magnetic stir bar, anhydrous SnCl₂ (25.00 g, 131.8 mmol) was dissolved in THF (200 mL) to form a cloudy solution. LiO^{t}Bu (21.32 g, 266.35 mmol) was added to the stirred SnCl₂ solution, resulting in a mild exotherm and the appearance of a thick tan/peach-colored mixture containing [Sn(O^{t}Bu)₂]₂. Both flasks were brought out of the glovebox, placed under N₂ on a Schlenk line, and the two flasks connected via ⅜″ PTFE tubing and supporting adapters. The 500 mL flask was outfitted with a heating mantle/hotplate combination and the [Sn(O^{t}Bu)₂]₂ solution transferred via cannula to the 500 mL flask with stirring over the course of 20 minutes. Upon complete addition the resulting dark green solution flask was equipped with a reflux condenser cooled to 5 °C and the reaction stirred at 75 °C for 12 hours, whereby, after 30 minutes the reaction presented as a mustard yellow mixture.

At this point, the reaction presented as an amber solution with a tan precipitate and the solvent was removed under reduced pressure with gentle heating (35 °C) to yield a tan/off-white solid matrix. The reaction was outfitted with an oven-dried (150 °C) in-line, coarse fritted filter adapter packed with glass wool and connected to a 24/40 jointed distillation adapter equipped with a 250 mL round bottom collection flask. The apparatus was outfitted with heat tape, a thermocouple, and wrapped with aluminum foil. The heat tape was warmed to 75 °C using a J-KEM temperature controller, the apparatus placed under reduced pressure, and the heating mantle raised to 60 °C. The collection flask was cooled with liquid N₂ and the heating mantle temperature raised to 95 °C with a baseline pressure of 60 mTorr. The product was collected in the receiving flask as a colorless white solid over the course of 4 hours. Total mass: 22.72 g, 41.91% yield. NMR collected on a C₆D₆ solution confirm the target molecule (Sn(O^{t}Bu)₄) has been synthesized in >99% purity by ¹¹⁹Sn-NMR.

### Example 4

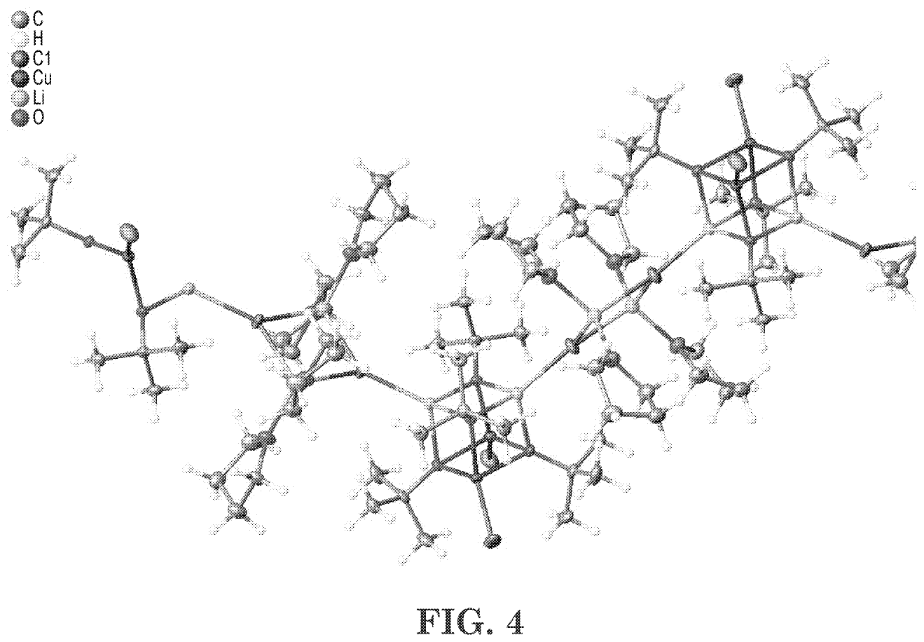

In a nitrogen-filled glovebox, CuCl₂ (2.0 g, 14.9 mmol) was placed in an amber 40 mL vial equipped with a magnetic stir bar and diluted in 20 mL of THF to form a dark brown mixture. LiO^{t}Bu (2.41 g, 30.0 mmol) was added directly to the stirred suspension, resulting in an exotherm and presentation of a dark green solution which was stirred at room temperature for 12 hours. At this point, the dark green solution was filtered through a 0.2 μm filter, and the resulting dark green solution dried under reduced pressure to yield a green free-flowing solid. The product was reconstituted in minimal THF and stored at −35 °C, whereby, amber rhombohedral crystals were present and analyzed by single crystal x-ray diffractometry to support formation of a product containing the formula Li₂CuCl₂ (O^{t}Bu)₂(THF)₂ which is shown in FIG. 4. The crystal data and structure refinement for the copper (II) chloride/alkoxide/lithium complex is shown in Table 1.

TABLE 1
Crystal data and structure refinement for Li₂CuCl₂(O^{t}Bu)₂(THF)₂

| Empirical formula | C₁₆ H₃₄ Cl₂ Cu Li₂ O₄ | |
|---|---|---|
| Formula weight | 438.75 | g/mol |
| Temperature | 100.00 | K |
| Wavelength | 0.71073 | Å |
| Crystal system | Monoclinic | |
| Space group | C 1 2/c 1 | |
| Unit cell dimensions | a = 18.7297(9) Å | α = 90°. |
| | b = 13.3962(6) Å | β = 97.201(2)°. |
| | c = 18.4656(8) Å | γ = 90°. |
| Volume | 4596.6(4) | Å3 |
| Z | 8 | |
| Density (calculated) | 1.268 | Mg/m3 |
| Absorption coefficient | 1.197 | mm−1 |

| F(000) | 1848 |
|---|---|
| Crystal size | 0.15 × 0.15 × 0.11 mm3 |
| Theta range for data collection | 1.874 to 26.731° |
| Index ranges | −23 <= h <= 23, −16 <= k <= |
| | 16, −23 <= 1 <= 23 |
| Reflections collected | 67279 |
| Independent reflections | 4890 [R(int) = 0.0432] |
| Completeness to theta = | 100.00% |
| 25.242° | |
| Absorption correction | Semi-empirical from equivalents |
| Max. and min. transmission | 0.7455 and 0.6709 |
| Refinement method | Full-matrix least-squares on F2 |
| Data/restraints/parameters | 4890/0/232 |
| Goodness-of-fit on F2 | 1.059 |
| Final R indices [I > 2sigma(I)] | R1 = 0.0199, wR2 = 0.0473 |
| R indices (all data) | R1 = 0.0245, wR2 = 0.0491 |
| Largest diff. peak and hole | 0.351 and −0.335 e · Å−3 |

### Example 5

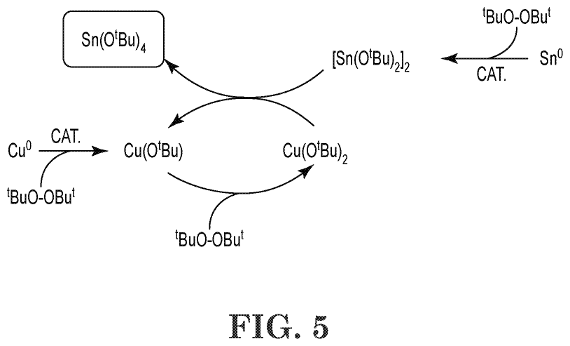

FIG. 5 is a schematic diagram of a method for making tin (IV) alkoxide. As shown in FIG. 5, elemental tin (Sn⁰) and elemental copper (Cu⁰) are reacted with a peroxide (^{t}BuO-OBu^{t}, where Bu^{t} is tert-butyl). The elemental tin, elemental copper, and peroxide are all added in the same vessel with a solvent and a catalyst. The elemental tin reacts with the peroxide to form tin (II) butoxide (Sn(O^{t}Bu)₂). The elemental copper reacts with the peroxide to first form copper (I) butoxide (Cu(O^{t}Bu)), which further reacts with the peroxide to form copper (II) butoxide (Cu(O^{t}Bu)₂). The copper (II) butoxide oxidizes the tin (II) butoxide to tin (IV) butoxide (Sn(O^{t}Bu)₄). After oxidizing the tin (II) butoxide, the copper (II) butoxide is reduced to copper (I) butoxide. The copper (I) butoxide can then be contacted with the peroxide to form copper (II) butoxide, which is then used to oxidize tin (II) butoxide. The resulting tin (IV) butoxide comprises less than 1% by weight of a halide based on a total weight of the tin (IV) butoxide.

### Example 6

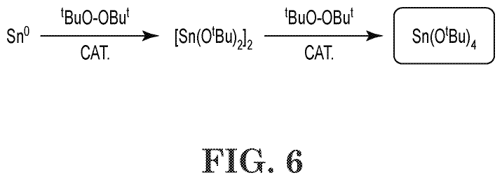

FIG. 6 is a schematic diagram of a method for making tin (IV) alkoxide. As shown in FIG. 6, elemental tin (Sn⁰) is reacted with a peroxide (^{t}BuO-OBu^{t}, where Bu^{t} is tert-butyl) in the presence of a catalyst and a solvent (not shown). The elemental tin reacts with the peroxide to form tin (II) butoxide (Sn(O^{t}Bu)₂). The tin (II) butoxide further reacts with the peroxide to form tin (IV) butoxide (Sn(O^{t}Bu)₄). The entire reaction takes place in the same vessel. The resulting tin (IV) butoxide comprises less than 1% by weight of a halide based on a total weight of the tin (IV) butoxide.

### Example 7

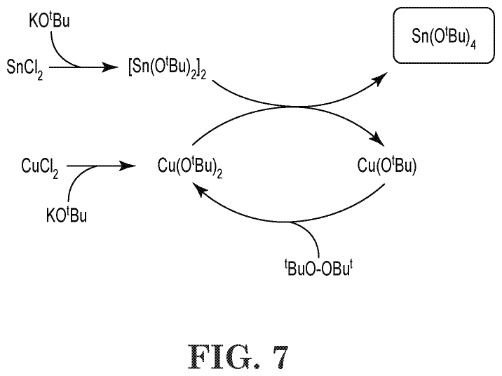

FIG. 7 is a schematic diagram of a method for making tin (IV) alkoxide. As shown in FIG. 7, tin (II) chloride (SnCl₂) and copper (II) chloride (CuCl₂) are reacted with a potassium butoxide (KO^{t}Bu, where ^{t}Bu is tert-butyl). The tin (II) chloride, copper (II) chloride, and potassium butoxide are all added in the same vessel with a solvent and a catalyst. The tin (II) chloride reacts with the potassium butoxide to form tin (II) butoxide (Sn(O^{t}Bu)₂). The copper (II) chloride reacts with the potassium butoxide to first form copper (II) butoxide (Cu(O^{t}Bu)₂). The copper (II) butoxide oxidizes the tin (II) butoxide to tin (IV) butoxide (Sn(O^{t}Bu)₄). After oxidizing the tin (II) butoxide, the copper (II) butoxide is reduced to copper (I) butoxide (Cu(O^{t}Bu)). A peroxide (^{t}BuO-OBu^{t}, where Bu^{t} is tert-butyl) can be added to the vessel and contacted with the copper (I) butoxide to form copper (II) butoxide, which is then used to oxidize tin (II) butoxide. The resulting tin (IV) butoxide comprises less than 1% by weight of a halide based on a total weight of the tin (IV) butoxide.

The following reference numerals are used throughout the drawings and specification: 100: method of making a tin (IV) alkoxide compound; 102: contacting step for forming a tin (II) alkoxide compound; 104: contacting step for forming a tin (IV) alkoxide compound; 200: method of making a tin (IV) alkoxide compound; 202: contacting step for forming a tin (II) alkoxide compound; 204: contacting step for forming a tin (IV) alkoxide compound; 300: method of making a tin (IV) alkoxide compound; 302: contacting step for forming a tin (II) alkoxide compound; 304: contacting step for forming a tin (IV) alkoxide compound.

### ASPECTS

Various Aspects are described below. It is to be understood that any one or more of the features recited in the following Aspect(s) can be combined with any one or more other Aspect(s).
Aspect 1. A method comprising:
   contacting at least a tin (II) alkoxide compound, a peroxide compound, and a solvent to form a tin (IV) alkoxide compound,
   wherein the tin (II) alkoxide compound comprises a compound of the formula:

Sn(OR¹)₂,
where:
   R¹ independently comprises a hydrocarbyl group;
wherein the peroxide compound comprises a compound of the formula:

R²—OR²,
where:
   R² independently comprises a hydrocarbyl group;
wherein the tin (IV) alkoxide compound comprises a compound of the formula:

Sn(OR¹)₂(OR²)₂,
where:
   R¹ and R² independently comprise a hydrocarbyl group.
Aspect 2. The method according to Aspect 1, wherein R¹ and R² comprise the same hydrocarbyl group.
Aspect 3. The method according to any one of Aspects 1-2, wherein each R¹ and R² is tert-butyl.
Aspect 4. The method according to any one of Aspects 1-3, wherein the contacting proceeds in the presence of a catalyst.
Aspect 5. The method according to any one of Aspects 1-4, wherein the catalyst comprises at least one of a metal halide, a metal oxide, or any combination thereof.
Aspect 6. The method according to any one of Aspects 1-5, wherein the catalyst comprises at least one of an iron trichloride, a manganese oxide, a copper (I) chloride, or any combination thereof.
Aspect 7. The method according to any one of Aspects 1-6, wherein the solvent comprises at least one of hexane, diethyl ether, tetrahydrofuran, toluene, benzene, xylene, dimethoxyethane, 2-methyltetrahydrofuran, or any combination thereof.
Aspect 8. The method according to any one of Aspects 1-7, wherein the tin (IV) alkoxide compound has a purity of at least 99% as measured by ¹¹⁹Sn-NMR and ¹H-NMR.
Aspect 9. The method according to any one of Aspects 1-8, wherein the tin (IV) alkoxide compound has a purity of at least 99% as measured by ICP-MS.
Aspect 10. The method according to any one of Aspects 1-9, wherein the tin (IV) alkoxide compound comprises less than 1% by weight of a halide based on a total weight of the tin (IV) alkoxide compound.
Aspect 11. The method according to any one of Aspects 1-10, further comprising heating at least the tin (II) alkoxide compound, the peroxide compound, and the solvent to form the tin (IV) alkoxide compound.
Aspect 12. A method comprising:
   contacting at least an elemental tin component, a peroxide compound, and a solvent to form a tin (IV) alkoxide compound,
   wherein the peroxide compound comprises a compound of the formula:

R¹O—OR¹,
where:
   R¹ independently comprises a hydrocarbyl group;
wherein the tin (IV) alkoxide compound comprises a compound of the formula:

Sn(OR¹)₄,
where:
   R¹ independently comprises a hydrocarbyl group.
Aspect 13. The method according to Aspect 12, wherein each R¹ comprises the same hydrocarbyl group.
Aspect 14. The method according to any one of Aspects 12-13, wherein each R¹ is tert-butyl.
Aspect 15. The method according to any one of Aspects 12-14, wherein the contacting proceeds in the presence of a catalyst.
Aspect 16. The method according to any one of Aspects 12-15, wherein the catalyst comprises at least one of an iron trichloride, a manganese oxide, copper (I) chloride or any combination thereof.
Aspect 17. The method according to any one of Aspects 12-16, wherein the solvent comprises at least one of hexane, diethyl ether, tetrahydrofuran, toluene, benzene, xylene, dimethoxyethane, 2-methyltetrahydrofuran, or any combination thereof.
Aspect 18. The method according to any one of Aspects 12-17, wherein the tin (IV) alkoxide compound has a purity of at least 99% as measured by ¹¹⁹Sn-NMR and ¹H-NMR.
Aspect 19. The method according to any one of Aspects 12-18, wherein the tin (IV) alkoxide compound has a purity of at least 99% as measured by ICP-MS.
Aspect 20. The method according to any one of Aspects 12-19, wherein the tin (IV) alkoxide compound comprises less than 1% by weight of a halide based on a total weight of the tin (IV) alkoxide compound.
Aspect 21. The method according to any one of Aspects 12-20, further comprising heating at least the elemental tin component, the peroxide compound, and the solvent to form the tin (IV) alkoxide compound.
Aspect 22. A method comprising:
   contacting at least a tin (II) alkoxide compound, a copper (II) alkoxide compound, and a solvent to form a tin (IV) alkoxide compound,
   wherein the tin (II) alkoxide compound comprises a compound of the formula:

Sn(OR¹)₂,
where:
   R¹ independently comprises a hydrocarbyl group;
wherein the tin (IV) alkoxide compound comprises a compound of the formula:

Sn(OR¹)₂(OR²)₂,
where:
   R¹ and R² independently comprise a hydrocarbyl group.
Aspect 23. The method according to Aspect 22, wherein the contacting comprises oxidizing the tin (II) alkoxide compound, with the copper (II) alkoxide compound, to form the tin (IV) alkoxide compound.
Aspect 24. The method according to any one of Aspects 22-23, wherein the copper (II) alkoxide compound comprises at least one of Cu(OR²)₂, Cu(OR²)X, or any combination thereof,
   where:
      R² independently comprises a hydrocarbyl group; and
      X comprises a halide.
Aspect 25. The method according to any one of Aspects 22-24, wherein R¹ and R² comprise the same hydrocarbyl group.
Aspect 26. The method according to any one of Aspects 22-25, wherein each R¹ and R² is tert-butyl.
Aspect 27. The method according to any one of Aspects 22-26, wherein the contacting proceeds in the presence of a catalyst.
Aspect 28. The method according to any one of Aspects 22-27, wherein the catalyst comprises at least one of an iron trichloride, a manganese oxide, copper (I) chloride, or any combination thereof.
Aspect 29. The method according to any one of Aspects 22-28, wherein the solvent comprises at least one of hexane, diethyl ether, tetrahydrofuran, toluene, benzene, xylene, dimethoxyethane, 2-methyltetrahydrofuran, or any combination thereof.
Aspect 30. The method according to any one of Aspects 22-29, wherein the tin (IV) alkoxide compound has a purity of at least 99% as measured by ¹¹⁹Sn-NMR and ¹H-NMR.
Aspect 31. The method according to any one of Aspects 22-30, wherein the tin (IV) alkoxide compound has a purity of at least 99% as measured by ICP-MS.
Aspect 32. The method according to any one of Aspects 22-31, wherein the tin (IV) alkoxide compound comprises less than 1% by weight of a halide based on a total weight of the tin (IV) alkoxide compound.
Aspect 33. The method according to any one of Aspects 22-32, further comprising heating at least the tin (II) alkoxide compound, the copper (II) alkoxide compound, and the solvent to form the tin (IV) alkoxide compound.
Aspect 34. A method comprising:
   contacting at least an elemental tin component, an elemental copper component, a peroxide compound, and a solvent to form a tin (IV) alkoxide compound,
   wherein the peroxide compound comprises a compound of the formula:

R¹O—OR¹,
where:
   R¹ independently comprises a hydrocarbyl group;
wherein the tin (IV) alkoxide compound comprises a compound of the formula:

Sn(OR¹)₄,
where:
   R¹ independently comprises a hydrocarbyl group.
Aspect 35. The method according to Aspect 34, wherein each R¹ comprises the same hydrocarbyl group.
Aspect 36. The method according to any one of Aspects 34-35, wherein each R¹ is tert-butyl.
Aspect 37. The method according to any one of Aspects 34-36, wherein the contacting proceeds in the presence of a catalyst.
Aspect 38. The method according to any one of Aspects 34-37, wherein the catalyst comprises at least one of an iron trichloride, a manganese oxide, copper (I) chloride, or any combination thereof.
Aspect 39. The method according to any one of Aspects 34-38, wherein the solvent comprises at least one of hexane, diethyl ether, tetrahydrofuran, toluene, benzene, xylene, dimethoxyethane, 2-methyltetrahydrofuran, or any combination thereof.
Aspect 40. The method according to any one of Aspects 34-39, wherein the tin (IV) alkoxide compound has a purity of at least 99% as measured by ¹¹⁹Sn-NMR and ¹H-NMR.
Aspect 41. The method according to any one of Aspects 34-40, wherein the tin (IV) alkoxide compound has a purity of at least 99% as measured by ICP-MS.
Aspect 42. The method according to any one of Aspects 34-41, wherein the tin (IV) alkoxide compound comprises less than 1% by weight of a halide based on a total weight of the tin (IV) alkoxide compound.
Aspect 43. The method according to any one of Aspects 34-42, further comprising heating at least the elemental tin component, the elemental copper component, the peroxide compound, and the solvent to form the tin (IV) alkoxide compound.
Aspect 44. A composition comprising:
   a tin (IV) alkoxide compound of the formula:

Sn(OR)₄,
where:
   R independently comprises a hydrocarbyl group;
wherein the composition comprises less than 1% by weight of a halide based on a total weight of the composition.
Aspect 45. The composition according to Aspect 44, wherein each R comprises the same hydrocarbyl group.
Aspect 46. The composition according to any one of Aspects 44-45, wherein each R is tert-butyl.
Aspect 47. The composition according to any one of Aspects 44-46, wherein the tin (IV) alkoxide compound has a purity of at least 99% as measured by ¹¹⁹Sn-NMR and ¹H-NMR.
Aspect 48. The composition according to any one of Aspects 44-47, wherein the tin (IV) alkoxide compound has a purity of at least 99% as measured by ICP-MS.
Aspect 49. A method comprising:
   contacting at least a tin (II) amide compound, a copper (II) amide compound, and a solvent to form a tin (IV) amide compound,
   wherein the tin (II) amide compound comprises a compound of the formula:

Sn(NR¹₂)₂,
where:
   R¹ independently comprises a hydrocarbyl group;
wherein the tin (IV) amide compound comprises a compound of the formula:

Sn(NR¹₂)₂(NR²₂)₂,
where:
R¹ and R² independently comprise a hydrocarbyl group.
Aspect 50. The method according to Aspect 49, wherein the contacting comprises oxidizing the tin (II) amide compound, with the copper (II) amide compound, to form the tin (IV) amide compound.
Aspect 51. The method according to any one of Aspects 49-50, wherein the copper (II) amide compound comprises at least one of Cu(NR²₂)₂, Cu(NR²₂)X, or any combination thereof,
   where:
      R² independently comprises a hydrocarbyl group; and
      X comprises a halide.
Aspect 52. The method according to any one of Aspects 49-51, wherein R¹ and R² comprise the same hydrocarbyl group.
Aspect 53. The method according to any one of Aspects 49-52, wherein each R¹ and R² is methyl.
Aspect 54. The method according to any one of Aspects 49-53, wherein the contacting proceeds in the presence of a catalyst.
Aspect 55. The method according to any one of Aspects 49-54, wherein the catalyst comprises at least one of an iron trichloride, a manganese oxide, copper (I) chloride, or any combination thereof.
Aspect 56. The method according to any one of Aspects 49-55, wherein the solvent comprises at least one of hexane, diethyl ether, tetrahydrofuran, toluene, benzene, xylene, dimethoxyethane, 2-methyltetrahydrofuran, or any combination thereof.
Aspect 57. The method according to any one of Aspects 49-56, wherein the tin (IV) amide compound has a purity of at least 99% as measured by ¹¹⁹Sn-NMR and ¹H-NMR.
Aspect 58. The method according to any one of Aspects 49-57, wherein the tin (IV) amide compound has a purity of at least 99% as measured by trace metal analysis.
Aspect 59. The method according to any one of Aspects 49-58, wherein the tin (IV) amide compound comprises less than 1% by weight of a halide based on a total weight of the tin (IV) amide compound.
Aspect 60. The method according to any one of Aspects 49-59, further comprising heating at least the tin (II) amide compound, the copper (II) amide compound, and the solvent to form the tin (IV) amide compound.
Aspect 61. A method comprising:
   contacting at least a copper (II) compound, a metal amide compound, and a solvent to form a copper (II) amide compound,
   wherein the copper (II) compound comprises a compound of the formula:

CuY₂,
where:
   Y independently comprises at least one of a halide, a sulfate, an acetate, an oxalate, an acetylacetonate, a nitrate, or any combination thereof;
wherein the metal amide compound comprises a compound of the formula:

M(NR¹₂)ₙ,
where:
   M comprises at least one of an alkali metal, an alkaline earth metal, or any combination thereof;
   R¹ independently comprises a hydrocarbyl group; and
   n is 1 or 2; and
wherein the copper (II) amide compound comprises a compound of the formula:

Cu(NR¹₂)₂,
where:
   R¹ independently comprises a hydrocarbyl group.
Aspect 62. The method according to Aspect 61, wherein the contacting comprises contacting at a temperature of −100 °C to 10 °C.
Aspect 63. The method according to any one of Aspects 61-62, wherein each R¹ comprises the same hydrocarbyl group.
Aspect 64. The method according to any one of Aspects 61-63, wherein each R¹ is methyl.
Aspect 65. A composition comprising:
   a tin (IV) amide compound of the formula:

Sn(NR₂)₄,
where:
   R independently comprises a hydrocarbyl group; and
wherein the composition comprises less than 1% by weight of a halide based on a total weight of the composition.
Aspect 66. The composition according to Aspect 65, wherein each R comprises the same hydrocarbyl group.
Aspect 67. The composition according to any one of Aspects 65-66, wherein each R is methyl.
Aspect 68. The composition according to any one of Aspects 65-67, wherein the tin (IV) amide compound has a purity of at least 99% as measured by ¹¹⁹Sn-NMR and ¹H-NMR.
Aspect 69. The composition according to any one of Aspects 65-68, wherein the tin (IV) amide compound has a purity of at least 99% as measured by ICP-MS.

What is claimed is:

1. A method comprising:
contacting at least a tin (II) alkoxide compound, a peroxide compound, and a solvent to form a tin (IV) alkoxide compound,
wherein the tin (II) alkoxide compound comprises a compound of the formula:
Sn(OR¹)₂,
where:
R¹ independently comprises a hydrocarbyl group;
wherein the peroxide compound comprises a compound of the formula:
R²O—OR²,
where:
R² independently comprises a hydrocarbyl group; and
wherein the tin (IV) alkoxide compound comprises a compound of the formula:
Sn(OR¹)₂(OR²)₂,
where:
R¹ and R² independently comprise a hydrocarbyl group.

2. The method of claim 1, wherein each R¹ and R² is tert-butyl.

3. The method of claim 1, wherein the contacting proceeds in the presence of a catalyst selected from a group consisting of: a metal halide, a metal oxide, and any combination thereof.

4. The method of claim 3, wherein the catalyst comprises at least one of an iron trichloride, a manganese oxide, a copper (I) chloride, or any combination thereof.

5. The method of claim 1, wherein the tin (IV) alkoxide compound has a purity of at least 99% as measured by ¹¹⁹Sn-NMR and ¹H-NMR.

6. The method of claim 1, wherein the tin (IV) alkoxide compound comprises less than 1% by weight of a halide based on a total weight of the tin (IV) alkoxide compound.

7. A method comprising:
contacting at least an elemental tin component, a peroxide compound, and a solvent to form a tin (IV) alkoxide compound,
wherein the peroxide compound comprises a compound of the formula:
R¹O—OR¹,
where:
R¹ independently comprises a hydrocarbyl group; and
wherein the tin (IV) alkoxide compound comprises a compound of the formula:
Sn(OR¹)₄,
where:
R¹ independently comprises a hydrocarbyl group.

8. The method of claim 7, wherein each R¹ is tert-butyl.

9. The method of claim 7, wherein the contacting proceeds in the presence of a catalyst selected from a group consisting of: iron trichloride, a manganese oxide, copper (I) chloride, and any combination thereof.

10. The method of claim 7, wherein the tin (IV) alkoxide compound has a purity of at least 99% as measured by ¹¹⁹Sn-NMR and ¹H-NMR.

11. A method comprising:
contacting at least a tin (II) alkoxide compound, a copper (II) alkoxide compound, and a solvent to form a tin (IV) alkoxide compound,
wherein the tin (II) alkoxide compound comprises a compound of the formula:
Sn(OR¹)₂,
where:
R¹ independently comprises a hydrocarbyl group; and
wherein the tin (IV) alkoxide compound comprises a compound of the formula:
Sn(OR¹)₂(OR²)₂,
where:
R¹ and R² independently comprise a hydrocarbyl group.

12. The method of claim 11, wherein the contacting comprises oxidizing the tin (II) alkoxide compound, with the copper (II) alkoxide compound, to form the tin (IV) alkoxide compound.

13. The method of claim 12, wherein the copper (II) alkoxide compound comprises at least one of Cu(OR²)₂, Cu(OR²)X, or any combination thereof,
where:
R² independently comprises a hydrocarbyl group; and
X comprises a halide.

14. The method of claim 11, further comprising heating at least the tin (II) alkoxide compound, the copper (II) alkoxide compound, and the solvent to form the tin (IV) alkoxide compound.

15. A method comprising:
contacting at least an elemental tin component, an elemental copper component, a peroxide compound, and a solvent to form a tin (IV) alkoxide compound,
wherein the peroxide compound comprises a compound of the formula:
R¹O—OR¹,
where:
R¹ independently comprises a hydrocarbyl group; and
wherein the tin (IV) alkoxide compound comprises a compound of the formula:
Sn(OR¹)₄,
where:
R¹ independently comprises a hydrocarbyl group.

16. The method of claim 15, wherein the contacting proceeds in the presence of a catalyst selected from a group consisting of: an iron trichloride, a manganese oxide, copper (I) chloride, and any combination thereof.

17. A method comprising:
contacting at least a tin (II) amide compound, a copper (II) amide compound, and a solvent to form a tin (IV) amide compound,
wherein the tin (II) amide compound comprises a compound of the formula:
Sn(NR¹₂)₂,
where:
R¹ independently comprises a hydrocarbyl group; and
wherein the tin (IV) amide compound comprises a compound of the formula:
Sn(NR¹₂)₂(NR²₂)₂,
where:
R¹ and R² independently comprise a hydrocarbyl group.

18. The method of claim 17, wherein the contacting comprises oxidizing the tin (II) amide compound, with the copper (II) amide compound, to form the tin (IV) amide compound.

19. The method of claim 17, wherein the copper (II) amide compound comprises at least one of Cu(NR²₂)₂, Cu(NR²₂)X, or any combination thereof,
where:
R² independently comprises a hydrocarbyl group; and
X comprises a halide.

20. The method of claim 17, wherein each R¹ and R² is methyl.
